(19) United States
(12) Patent Application Publication
(10) Pub. No.: US 2006/0210921 A1
(43) Pub. Date: Sep. 21, 2006

(54) Positive photosensitive composition and image recording material using the same

(75) Inventor: Kotaro Watanabe, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/375,254

(22) Filed: Mar. 15, 2006

(30) Foreign Application Priority Data
Mar. 15, 2005 (JP) 2005-73819

(51) Int. Cl. G03C 1/76

(52) U.S. Cl. 430/270.1

(57) ABSTRACT

The invention discloses a positive photosensitive composition comprising (A) a compound represented by the following formula (1) which is decomposed by exposure to light to generate an acid, (B) a high-molecular compound having a phenolic hydroxyl group and (C) an infrared-light absorber. The invention also provides a positiveplanographic printing plate precursor using this photosensitive composition for the recording layer. 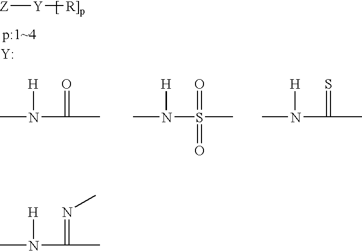 In the formula, R represents an alkyl, cycloalkyl, aralkyl or aryl group having an acid group, Y represents a bivalent to tetravalent connecting group having at least one partial structure selected from the following group of partial structures or a terminal group selected from one of the partial structures and a terminal hydrogen atom, and Z does not exist when Y is a terminal group, but represents a monovalent to tetravalent connecting group or terminal group when Y is a connecting group.

### CROSS-REFERENCE TO RELATED APPLICATION

This application claims priority under 35 USC 119 from Japanese Patent Application No. 2005-073819, the disclosure of which is incorporated by reference herein.

### BACKGROUND OF THE INVENTION

1. Field of the Invention

The present invention relates to a positive photosensitive composition, and, particularly to a positive photosensitive composition that has a large difference in solubility to an alkali developer between an exposed part and an unexposed part and is useful as a recording layer of a planographic printing plate precursor for use with infrared lasers for so-called direct plate-making enabling direct plate-making from digital signals of computers or the like, and to a positive image recording material using the positive photosensitive composition.

2. Description of the Related Art

Recent developments in lasers have been remarkable, particularly in solid lasers and semiconductor lasers having a light-emission region in the near-infrared to infrared regions, of which high-power and small-sized lasers have come to be easily available. These lasers are very useful as an exposure light source used in making plates directly from digital data of computers or the like.

Novolac resins or the like are used as a resin soluble in an aqueous alkali solution for conventionally known positive photosensitive image-forming materials for use with infrared lasers for direct plate-making.

For example, as a positive photosensitive image-forming material, one obtained by adding a material which absorbs light to generate heat and a positive photosensitive material such as various onium salts and quinonediazide compounds to a resin soluble in an aqueous alkali solution having a phenolic hydroxyl group is disclosed. Specifically, the positive photosensitive compound works as a dissolution inhibitor that substantially lowers the solubility of the resin to an aqueous alkali solution in an image portion and does not exhibit dissolution inhibiting ability in a non-image part after being heated, so that the non-image part can be removed by developing, thereby forming an image (see, for example, Japanese Patent Application Laid-open (JP-A) No. 7-285275).

There are also materials disclosed as positive photosensitive image-forming material, these materials comprising a material that absorbs light to generate heat and a resin whose solubility to an aqueous alkali solution is changed by heat, wherein an image portion has low solubility to an aqueous alkali solution, and a non-image portion has increased solubility to an aqueous alkali solution due to the heat and can be removed by developing to thereby form an image (see, for example, WO97/39894 pamphlet and European Patent Application Laid-Open No. 0823327A2 specification).

Such a recording layer is constituted of an alkali-soluble resin as its major component and therefore has the problem that the strength of the image portion is insufficient and the image portion is therefore easily damaged. The recording layer also has the problem that when wiping of the surface of the planographic printing plate by a plate cleaner is carried out during a continuous printing operation, the surface of the plate is easily damaged by an organic solvent in the cleaner, leading to a deterioration in printing durability. When, as countermeasures, a compound exhibiting a strong dissolution inhibiting function is used with the aim of improving the strength of the surface, or a means is taken to improve the water resistance of the surface of the recording layer, there is a tendency that the developability is reduced, bringing about a reduction in recording sensitivity and a likelihood of generation of a residual film.

A wide variety of compounds are being investigated as dissolution inhibitors. Among these, it is known that, especially, an onium salt-based dissolution inhibitor exhibits a very strong dissolution inhibiting function. However, the addition of a general onium salt compound gives rise to the problem of a reduction in sensitivity even though the effect of improving the alkali resistance of an unexposed part due to the high dissolution inhibiting function is attained.

As a measure taken to overcome this problem, a photosensitive composition using a specific onium salt has been disclosed (see, for example, Japanese Patent No. 2577718). It has come to be understood that onium salts having such a specific structure have excellent characteristics of both high dissolution inhibiting ability and high sensitivity.

However, in practical use, the photosensitive composition using a known onium salt-based dissolution inhibitor still has room for improvement in the difference between the developability of an exposed portion and the ability to resist developing of an unexposed portion, and the present situation is that there is a need for further improvement.

### SUMMARY OF THE INVENTION

In view of this situation, it is an object of the invention to provide a positive photosensitive composition which is superior with regard to the difference in solubility in a developer between an exposed portion and an unexposed portion (dissolution discrimination), and is superior in the chemical resistance of the unexposed portion. Another object of the invention is to provide a positive image recording material applicable to a heat-mode, which uses the positive photosensitive composition for a recording layer and is superior in dissolution discrimination and chemical resistance of an image portion.

The inventors have investigated and, as a result, found that the above objects can be attained by use of an acid generator capable of generating an acid having a specific structure and these findings have led to the completion of the invention.

According to a first aspect of the invention, there is provided a positive photosensitive composition comprising (A) a compound represented by the following formula (1) which is decomposed by exposure to light to generate an acid, (B) a high-molecular compound having a phenolic hydroxyl group, and (C) an infrared-light absorber,
Z-Y—[R]ₚ General Formula (1)
p: 1˜4

wherein R represents an alkyl, cycloalkyl, aralkyl or aryl group having an acid group, Y represents a bivalent to tetravalent connecting group having at least one partial structure selected from the following group of partial structures or a terminal group selected from one of the following partial structures and a terminal hydrogen atom and Z does not exist when Y is a terminal group, but represents a monovalent to tetravalent connecting group or terminal group when Y is a connecting group.

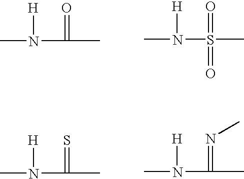

According to a second aspect of the invention, a positive image recording material applicable to a heat mode comprising a support and a recording layer which is disposed on the support and comprising a specific photosensitive composition, wherein the photosensitive composition of the recording layer contains (A) a compound represented by the following formula (1) which is decomposed by exposure to light to generate an acid, (B) a high-molecular compound having a phenolic hydroxyl group, and (C) an infrared-light absorber;
Z-Y—[R]ₚ General Formula (1)
p: 1˜4

wherein R represents an alkyl, cycloalkyl, aralkyl or aryl group having an acid group, Y represents a bivalent to tetravalent connecting group having at least one partial structure selected from the following group of partial structures, or a terminal group selected from one of the partial structures and a terminal hydrogen atom, and Z does not exist when Y is a terminal group, but represents a monovalent to tetravalent connecting group or terminal group when Y is a connecting groups

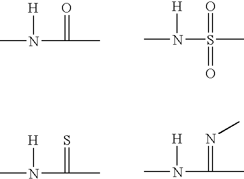

According to a third aspect of the invention, a positive photosensitive composition comprising;

(A-1) a sulfonium salt or an iodonium salt having a compound represented by the following formula (1-1) as a counter anion,

(B) a high-molecular compound having a phenolic hydroxyl group; and

(C) an infrared-light absorber:
Z-Y—[R]ₚ General Formula (1-1)
p: 1˜4

wherein R represents an alkyl, cycloalkyl, aralkyl or aryl group having an anion group, Y represents a bivalent to tetravalent connecting group having at least one partial structure selected from the following group of partial structures or a terminal group selected from one of the partial structures and a terminal hydrogen atom and Z does not exist when Y is a terminal group, but represents a monovalent to tetravalent connecting group or terminal group when Y is a connecting group.

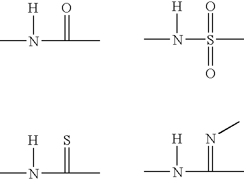

According to a forth aspect of the invention, a positive photosensitive composition comprising:

(A-2) a compound which is selected from a sulfonate ester, a disulfone, a sulfone imide, a diazo disulfone, a ketosulfone, and a carboxylic acid ester, and decomposed by exposure to light to generate a sulfonic acid anion represented by following formula (1-3);

(B) a high-molecular compound having a phenolic hydroxyl group; and

(C) an infrared-light absorber:
Z-Y—[R]ₚ General Formula (1-3)
p: 1˜4

wherein R represents an alkyl, cycloalkyl, aralkyl or aryl group having an sulfonic acid group, Y represents a bivalent to tetravalent connecting group having at least one partial structure selected from the following group of partial structures or a terminal group selected from one of the partial structures and a terminal hydrogen atom and Z does not exist when Y is a terminal group, but represents a monovalent to tetravalent connecting group or terminal group when Y is a connecting group.

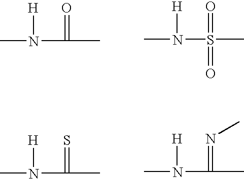

The compound (A) represented by the formula (1) used in the present invention (herein referred to as “specific acid generator” where appropriate) which is decomposed by exposure to light to generate an acid is a compound having an amide bond which forms a thermally reversible hydrogen bond in its molecule.

When a film is formed using the positive photosensitive composition containing such a specific acid generator, the acid generator forms a strong interaction with the alkali-soluble resin in the film. Also, because the specific acid generator is highly compatible with the alkali-soluble resin, the strong chemical resistance of the specific acid generator itself can greatly contribute to the chemical resistance of the film constituted of the composition having alkali-soluble resin as it major component. It is inferred that, therefore, if the positive photosensitive composition having such a specific acid generator is used, a film superior in resistance to alkali developing and in chemical resistance is formed.

Also, release from this interaction is obtained rapidly when the specific acid generator is decomposed by exposure to light and also, the acid generated in a non-image portion (exposed portion) draws the acid group of the alkali-soluble resin near thereto by the amide bond in its structure. This promotes the solubility of the resin to an alkali developer, with the result that the recording layer is removed rapidly and dispersed in the developer. It is thought that because the hydrophilic surface of the support can be exposed without generating a residual layer, the generation of stains in the non-image portion can be effectively suppressed.

In the above manner, a high dissolution inhibiting function caused by the interaction in an unexposed portion is exhibited in an unexposed portion, and a rapid release from the interaction is obtained in a light-exposed portion. Also, a development promoting effect due to the characteristics of the generated acid is obtained. It is considered that, from these reasons, excellent dissolution discrimination was attained.

Therefore, the image portion of the positive image recording material,which comprises a recording layer comprising the positive photosensitive composition of the invention, is superior in development resistance and chemical resistance. Also, in its non-image portion, the recording layer is rapidly removed and dispersed in a developer, making it possible to expose the hydrophilic surface of the support without generating any residual film. Namely, excellent dissolution discrimination is obtained, and a high-quality printed product free from any stains in the non-image portion is obtained.

### DETAILED DESCRIPTION OF THE INVENTION

The invention will be explained in detail.

The positive photosensitive composition of the invention contains (A) a compound represented by the formula (1) which is decomposed by exposure to light to generate an acid, (B) a high-molecular compound having a phenolic hydroxyl group and (C) an infrared-light absorber as essential components, and other components according to the need.

Each component contained in the recording layer of the positive image forming material of the invention will be explained one by one. First, (A) a compound represented by the formula (1) which is decomposed by exposure to light to generate an acid will be explained.

[(A) A Compound Represented by the Formula (1) which is Decomposed by Exposure to Light to Generate an Acid]

(A) A compound (specific acid generator) represented by the formula (1) which is decomposed by exposure to light to generate an acid and is used in the invention is decomposed by supplying energy by means of exposure to light or heating to generate an acid having the structure represented by the following formula (1);
Z-Y—[R]ₚ General Formula (1)
p: 1˜4

wherein R represents an alkyl, cycloalkyl, aralkyl or aryl having an acid group, Y represents a bivalent to tetravalent connecting group having at least one partial structure selected from the following group of partial structures or a terminal group selected from one of the partial structures and a terminal hydrogen atom, and Z does not exist when Y is a terminal group and represents a monovalent to tetravalent connecting group or terminal group when Y is a connecting group.

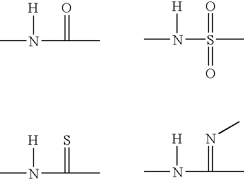

The specific acid generator according to the invention can be a compound which generates acid due to light exposure or heat, examples which can be given thereof including compounds listed in paragraphs [0039] to [0063] of Japanese Patent Application Laid-Open (JP-A) No. 10-282644, the disclosure of which, together with the disclosure of the following referenced documents, being incorporated by reference herein.

Specific examples which can be given also include the following onium salts: diazonium salts, such as those described by S. I. Schlesinger, in Photogr. Sci., Eng., 18, 387 (1974), and by T. S. Bal et al. in Polymer, 21, 423 (1980); ammonium salts, such as those described in the specifications of U.S. Pat. Nos. 4,069,055, and 4,069,056, and in JP-A 3-140,140; phosphonium salts, such as those described by D. C. Necker et al. in Macromolecules, 17, 2468 (1984), by C. S. Wren et al. in the Teh Proc. Conf. Rad. Curing ASIA, p478 Tokyo, October (1988), and the specification of U.S. Pat. Nos. 4,069,055 and 4,069,056; iodonium salts, such as those described by J. V. Crivello et al. in Macromolecules, 10(6), 1307 (1977), Chem. & Eng. News, November 28, p31 (1988), the specifications of European Patent (EP) No. 104,143, U.S. Pat. No. 339,049 and 410,201, JP-A Nos. 2-150,848 and 2-296,514; sulfonium salts, such as those described by J. V. Crivello et al. in Polymer J. 17, 73 (1985), J. V. Crivello et al. J. Org. Chem., 43, 8055 (1978), W. R. Watt et al. in the J. Polymer Sci., Polymer Chem. Ed., 22, 1789 (1984), J. V. Crivello et al. Polymer Bull., 14, 279 (1985), J. V. Criveuo et al., Macromolecules, 14(5), 1141 (1981), J. V. Crivello et al. J. Polymer Sci., Polymer Chem. Ed., 17, 2877 (1979), EP No. 370,693, U.S. Pat. No. 3,902,114, EP Nos. 288,567, 297,443, 297,442, U.S. Pat. Nos. 4,933,377, 410,201, 339,049, 4,760,013, 4,734,444, and 2,833,827, German Patent Nos. 2,904,626, 3,604,580, and 3,604,581; selenonium salts, such as those described by J. V. Crivello et al. in Macromolecules, 10 (6), 1807 (1977), and J. V. Crivello et al. in J. Polymer Sci., Polymer Chem. Ed., 17, 1047 (1979); arsonium salts, such as those described in C. S. Wen et al, Teh. Proc Conf. Rad. Curing ASIA, p478 Tokyo, October (1988). Other specific examples are: compounds which undergo photo-decomposition to generate sulfonic acid, typified by iminosulfonates, such as those described by M. TuNooka et al. in Polymer Preprints Japan, 35 (8), G. Berner et al. in J. Rad. Curing, 13 (4), W. J. Mijs et al. in Coating Technol., 55 (697), 45 (1983), Akzo, H Adachi et al. in Polymer Preprints, Japan, 37 (3), EP Nos. 0199,672, 84515, 199,672, 044,11.5, 0101,122, U.S. Pat. Nos. 4,618,564, 4,371,605, 4,431,774, JP-A Nos. 64-18143, 2-245756, and 4-365048; and disulfone compounds, such as those described in JP-A 61-166544. Other acid generators which can be used are sulfonate esters, disulfones, sulfone imides, diazo disulfones, ketosulfones, and carboxylic acid esters.

In the formula (1), R represents an alkyl, cycloalkyl, aralkyl or aryl group having an acid group.

When R represents an alkyl group having an acid group in the formula (1), the alkyl group is preferably an alkyl group having 1 to 20 carbon atoms and may be any of a straight alkyl group, an alkyl group having a branched chain, or a cyclic cycloalkyl group. The alkyl group and cycloalkyl group may further have a substituent,

Among these groups, straight-chain alkyl groups having 1 to 12 carbon atoms, branched alkyl groups having 3 to 12 carbon atoms, and cyclic alkyl groups having 5 to 10 carbon atoms are more preferable. Straight-chain alkyl groups having 1 to 8 carbon atoms and cyclic alkyl groups having 5 to 7 carbon atoms are still more preferable, and straight-chain alkyl groups having 3 to 7 carbon atoms are most preferable.

Specific examples of the above alkyl group may include a methyl group, an ethyl group, a propyl group, a butyl group, a pentyl group, a hexyl group, a heptyl group, an octyl group, a nonyl group, a decyl group, an undecyl group, a dodecyl group, a tridecyl group, a hexadecyl group, an octadecyl group, an eicosyl group, an isopropyl group, an isobutyl group, an s-butyl group, a t-butyl group, an iso-pentyl group, a neopentyl group, a 1-methylbutyl group, an isohexyl group, a 2-ethylhexyl group, a 2-methylhexyl group, a cyclohexyl group, a cyclopentyl group and a 2-norbornyl group.

Examples of the substituent which may be introduced into the alkyl group include an alkyl group, an aryl group, a halogen atom an alkoxy group, an alkoxycarbonyl group, an acyloxy group, a cyano group, a hydroxyl group, an alkylthio group, an arylthio group, an alkyl halide group, a nitro group and an amino group.

When R in the formula (1) represents an aralkyl group having an acid group, the aralkyl group is preferably alkyl groups having 4 to 14 carbon atoms and substituted with an aryl group.

Specific examples of the above aralkyl group include a phenylbutyl group, a phenylpentyl group, a phenylhexyl group and a phenyloctyl group.

The aralkyl group may be those having a substituent and examples of the substituent which may be introduced include the same examples given as the alkyl group.

When R in the formula (1) represents an aryl group, examples of the aryl group include aryl groups having 6 to 30, preferably 6 to 20 and particularly preferably 6 to 12 carbon atoms.

Specific examples of the above aryl group include a phenyl group, a p-methylphenyl group and a naphthyl group.

Examples of the substituent which may be introduced into the aryl group may include an alkyl group, an aryl group, an alkenyl group, an alkinyl group, an amino group, an alkoxy group, an aryloxy group, an acyl group, an alkoxycarbonyl group, an aryloxycarbonyl group, an acyloxy group, an acylamino group, an alkoxycarbonylamino group, an aryloxycarbonylamino group, a sulfonylamino group, a sulfamoyl group, a carbamoyl group, an alkylthio group, an arylthio group, a sulfonyl group, a hydroxyl group, a mercapto group, a halogen atom, a cyano group, a sulfo group, a carboxyl group and a nitro group. These groups may be further substituted.

Also, as the acid group to be introduced into the alkyl group, cycloalkyl group, aralkyl group or aryl group, any acid group having a hydrogen atom capable of dissociating an aqueous alkali solution may be preferably used. The pKa of the acid group is preferably 15 or less, more preferably 13 or less, and particularly preferably 2 to 11 from the viewpoint of alkali-solubility.

As such an acid group, for example, the following groups (1) to (6) are preferable from the viewpoint of solubility in an alkali developer.

(1) Phenolic hydroxyl group (—Ar—OH).

(2) Sulfonamide group (—SO₂NH—R¹).

(3) Substituted sulfonamide-based acid group (hereinafter referred to as “active amide group”) (SO₂NHCOR —SO₂NHSO₂R¹ and —CONHSO₂R¹).

(4) Carboxy group (—CO₂H)

(5) Sulfonic acid group (—SO₃H).

(6) Phosphonic acid group (—PO₃H₂).

In the formulae (1) to (6), Ar represents a divalent aryl connecting group which may have a substituent and R¹ represents a hydrogen atom or a hydrocarbon group which may have a substituent. Not only the acid groups, but also functional groups, such as (7) a mercapto (—SH) group which can be decomposed to be acid groups, are included in the acid group which can be introduced into R in the invention.

Among the acid groups selected from the above (1) to (7), (1) a phenolic hydroxyl group, (2) a sulfonamide group, (3) an active imide group, (4) a carboxy group and (5) a sulfonic acid group are preferable, and particularly, (3) an active imide group and (5) a sulfonic acid group are preferable.

Such acid group may be present in plural in one R. The number of acid groups in one R is preferably about 1 to 4 and more preferably about 1 to 2.

Among these groups, an unsubstituted aryl group having an acid group is preferable as R in the formula (1).

Next, Y in the formula (1) will be explained in detail. Y represents a connecting group connected to Z which will be explained later or a terminal group with a terminal hydrogen atom. When Y represents the connecting group, Y is a group having any one of two to four valences and particularly a group known to produce a strong interaction with a dissociable hydrogen atom in the aqueous alkali-soluble polymer. Specifically, Y is a group having the following partial structure.

Here, the description “having the following partial structure” means that Y as a connecting group or a terminal group has at least one of the above partial structures and Y may have a plurality of the above partial structures. Therefore, Y may be, for example, the above partial structure itself, a group formed by connecting a plurality of these partial structures or a group obtained by connecting the above partial structure with a hydrocarbon group or the like.

Particularly, in the formula (1), specific and preferable examples of the compounds having the above partial structure include amide, sulfonamide, urea, urethane and thiourea.

Next, Z in the formula (1) will be explained in detail. Z is not present when Y is a terminal group and represents a connecting group or terminal group having p valences when Y represents a connecting group. p denotes an integer from 1 to 4.

Z is preferably a hydrocarbon connecting group or terminal group which may have a substituent. Examples of the hydrocarbon connecting group include straight-chain, branched or cyclic alkylene or alkyl groups having I to IS carbon atoms; arylene or aryl groups having 6 to 20 carbon atoms; straight-chain, branched or cyclic alkenylene group or alkenyl group having 2 to 18 carbon atoms and straight-chain, branched or cyclic alkinylene or alkinyl groups having 2 to 18 carbon atoms. Specific and preferable examples of Z include monovalent groups such as a methyl group, an ethyl group, a propyl group, an isopropyl group, a butyl group, an isobutyl group, a tertiary butyl group, a secondary butyl group, a pentyl group, a hexyl group, a cyclopentyl group, a cyclohexyl group, an octyl group, a benzyl group, a phenyl group, a naphthyl group, an anthracenyl group, an allyl group and a vinyl group. In the case of bi- or higher-valent groups, those obtained by removing hydrogen atoms equal in number to the number of valences from these monovalent groups are preferable. When Z has a substituent, preferable examples of the substituent include an alkoxy group having 12 or less carbon atoms, a halogen atom and a hydroxyl group.

The (A) specific acid generator according to the invention may be (A-1) a sulfonium salt or an iodonium salt having a compound represented by the following formula (1-1) as a counter anion.
Z-Y—[R]ₚ General Formula (1-1)
p: 1˜4

wherein R represents an alkyl, cycloalkyl, aralkyl or aryl group having an anion group, Y represents a bivalent to tetravalent connecting group having at least one partial structure selected from the following group of partial structures or a terminal group selected from one of the partial structures and a terminal hydrogen atom and Z does not exist when Y is a terminal group, but represents a monovalent to tetravalent connecting group or terminal group when Y is a connecting group.

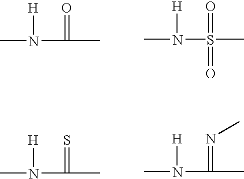

R having the anion group in the general formula (1-1) is a group dissociated from R having the acid group in the general formula (1). Y, Z and p in the formula (1-1) are the same as Y, Z and p in the formula (1).

The (A-1) sulfonium salt is preferably a triaryl sulfonium salt or iodonium salt is preferably a diaryl iodonium salt. The (A-1) sulfonium salt is represented by the following general formula (1-2):

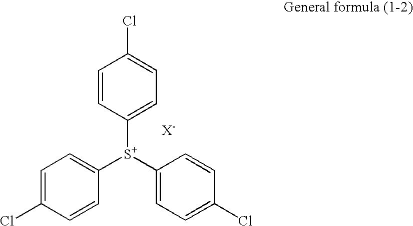

wherein x represents the compound represented by the formula (1-1).

The anion group in the general formula (1-1) is preferably a group dissociated from a group selected frown an active imide group, a sulfonic acid group and a phosphonic acid group.

Moreover, the (A) specific acid generator according to the invention may be (A-2) a compound which is selected from a sulfonate ester, a disulfone, a sulfone imide, a diazo disulfone, a ketosulfone, and a carboxylic acid ester, and decomposed by exposure to light to generate a sulfonic acid anion represented by following formula (1-3);
Z-Y—[R]ₚ General Formula (1-3)
p: 1˜4

wherein R represents an alkyl, cycloalkyl, aralkyl or aryl group having an sulfonic acid group, Y represents a bivalent to tetravalent connecting group having at least one partial structure selected from the following group of partial structures or a terminal group selected from one of the partial structures and a terminal hydrogen atom and Z does not exist when Y is a terminal group, but represents a monovalent to tetravalent connecting group or terminal group when Y is a connecting group.

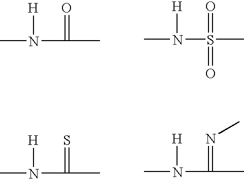

R in the general formula (1-2) is the same as R in the general formula (1) except that the acid group in formula (1) is sulfonic acid group. Y, Z and p in the formula (1-1) are the same as Y, Z and p in the formula (1).

The specific examples of the (A-2) compound include the following exemplified compounds (T-1) to (T-5) or the like.

Preferable and specific examples of the specific acid generator which is the component (A) in the invention will be given below, wherein when the specific acid generators are onium salt compounds (exemplified compounds (A-1) to (S-50)), the onium cationic part and a strong acid residue (anionic part) which is the counter anion are shown and when the specific acid generators are other compounds (exemplified compounds (T-1) to (T-10)), each structure is shown. However, the invention is not limited to the examples herein.

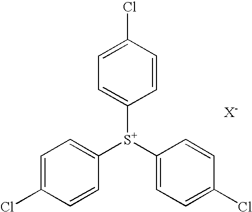

X⁻:
(A-type)

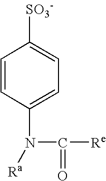

(B-type)

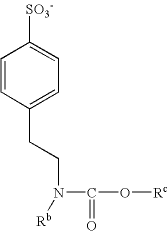

(C-type)

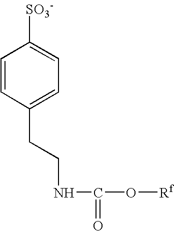

| | —R^{a} | —R^{e} |
|---|---|---|
| (A-1) | —H | —H |
| (A-2) | —H | —CH₃ |
| (A-3) | —H | —C₂H₅ |
| (A-4) | —H | —Pr(i) |
| (A-5) | —H | —Bu(t) |
| (A-6) | —H | —Ph |

| | —R^{b} | —R^{c} |
|---|---|---|
| (B-1) | —H | —C₂H₃ |
| (B-2) | —H | —Pr(i) |
| (B-3) | —H | —Bu(n) |
| (B-4) | —H | —Bu(t) |
| (B-5) | —H | —Ph |
| (B-6) | —H | 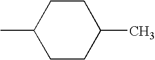 |

| | R^{f} |
|---|---|
| (C-1) | —C₂H₅ |
| (C-2) | —Pr(i) |
| (C-3) | —Bu(n) |
| (C-4) | —Ph |
| (C-5) | —CH₂—Ph |

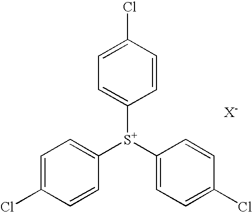 X⁻:

| | |
|---|---|
| (D-type) | (E-type) |
| 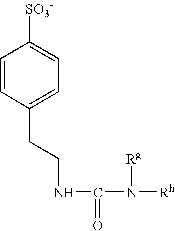 | 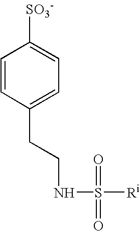 |
| (F-type) | |
| 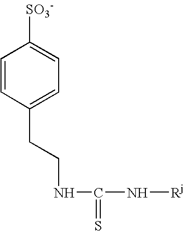 | |

| | —R^{g} | —R^{h} | | —Rⁱ |
|---|---|---|---|---|
| (D-1) | —H | —Bu(n) | (E-1) | —C₂H₅ |
| (D-2) | —H | 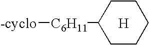 | (E-2) | —Ph |
| (D-3) | —H | —Ph | (E-3) | 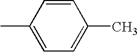 |
| (D-4) | —H | 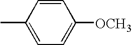 | (E-4) | 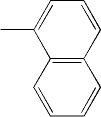 |
| (D-5) | —H | 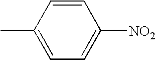 | | |
| (D-6) | —CH₃ | —CH₃ | | |

| | —R^{j} |
|---|---|
| (F-1) | 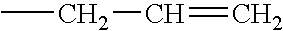 |
| (F-2) | —Bu(n) |
| (F-3) | —Ph |

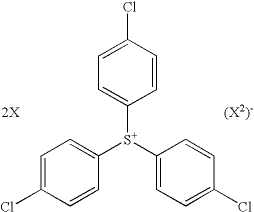 (X²)⁻:
(G-type)

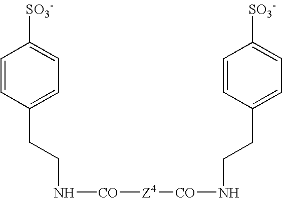

| | —Z^{a}— |
|---|---|
| (G-1) | —(CH₂)₄) |
| (G-2) | 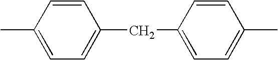 |
| (G-3) | 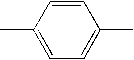 |
| (G-4) | —NH—(CH₂)₃—NH— |
| (G-5) | 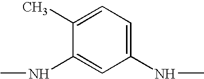 |
| (G-6) | 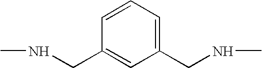 |
| (G-7) | —O—(CH₂)₃—O— |
| (G-8) | 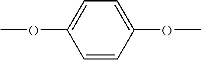 |

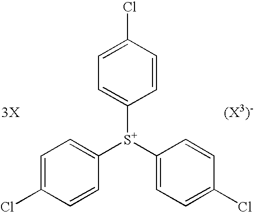 (X³)⁻:
(H-type)

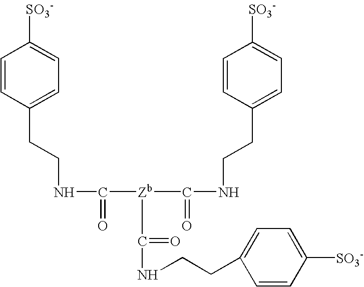

| | 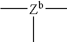 |
|---|---|
| (H-1) | 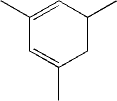 |
| (H-2) | 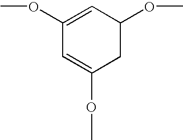 |
| (H-3) | 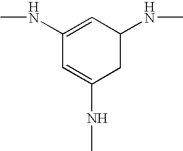 |

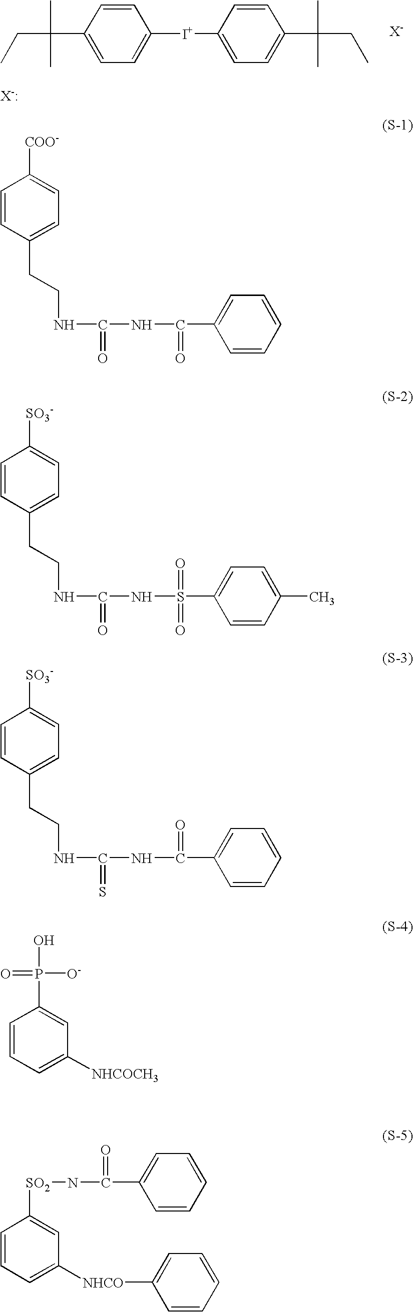

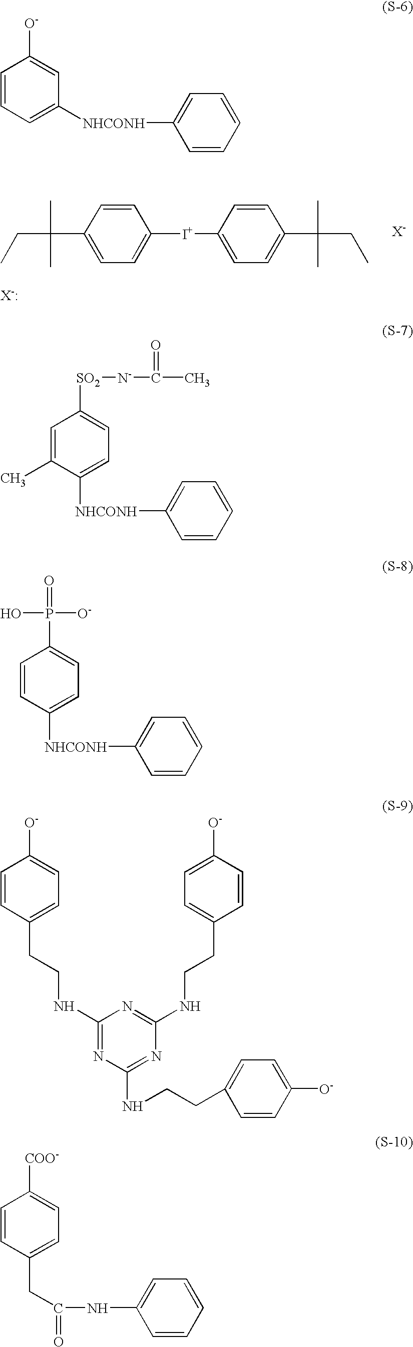

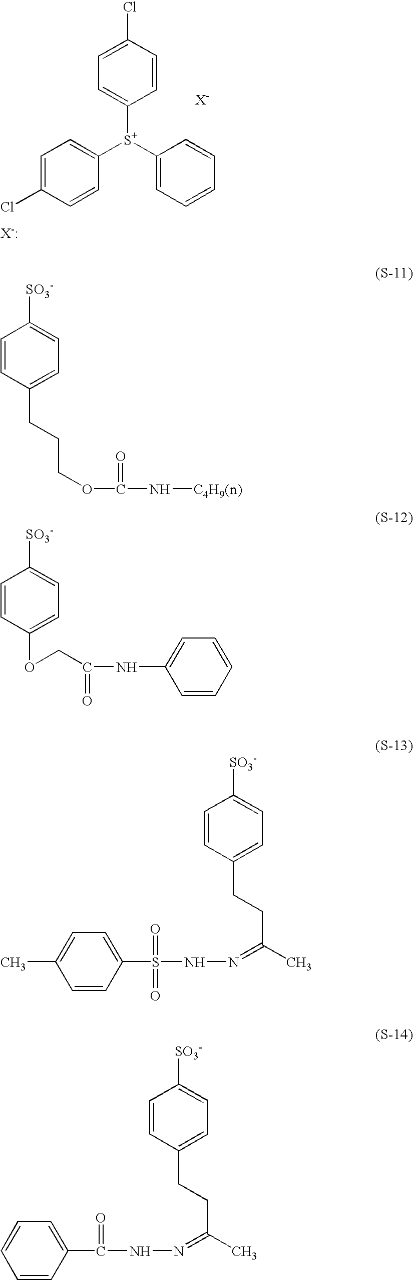

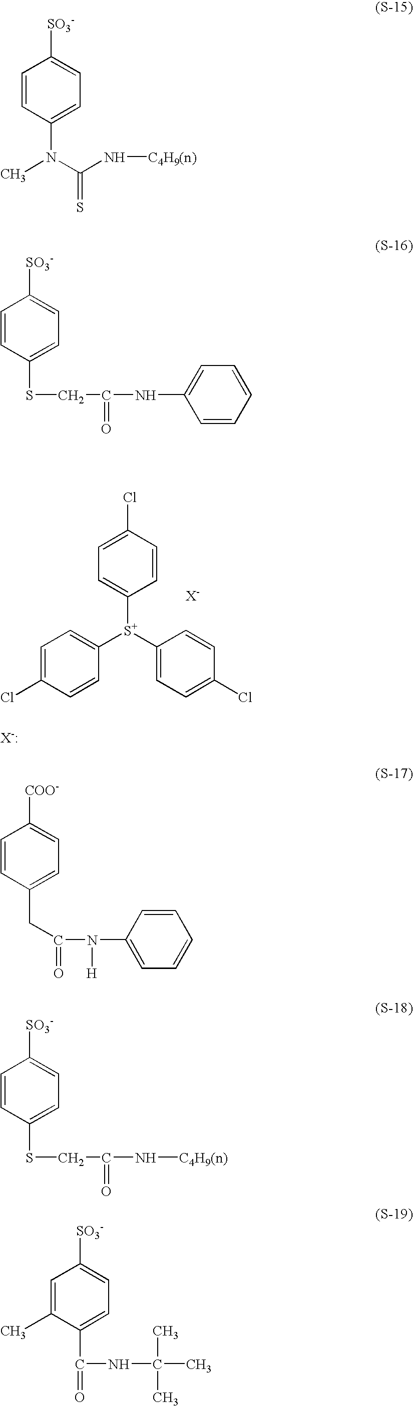

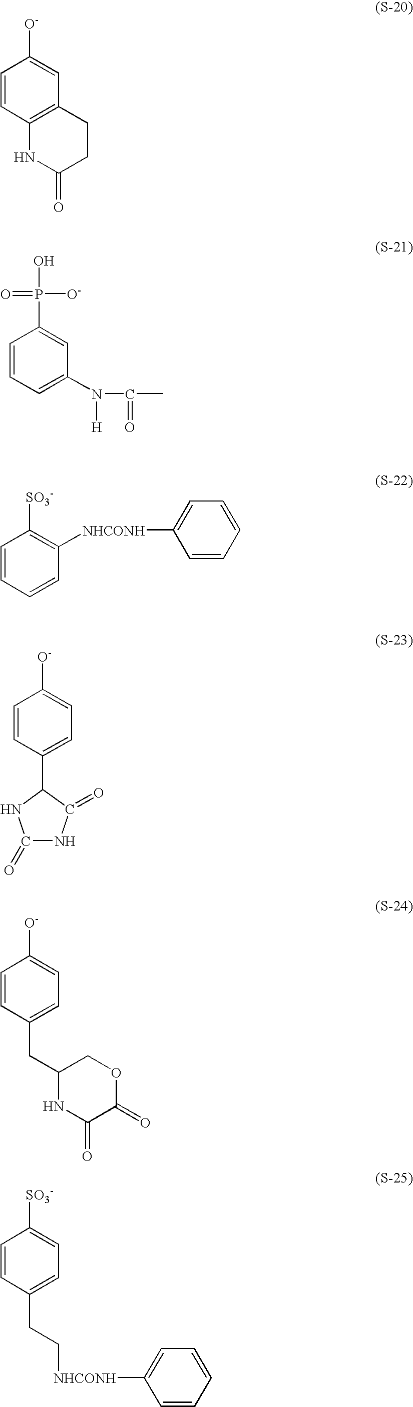

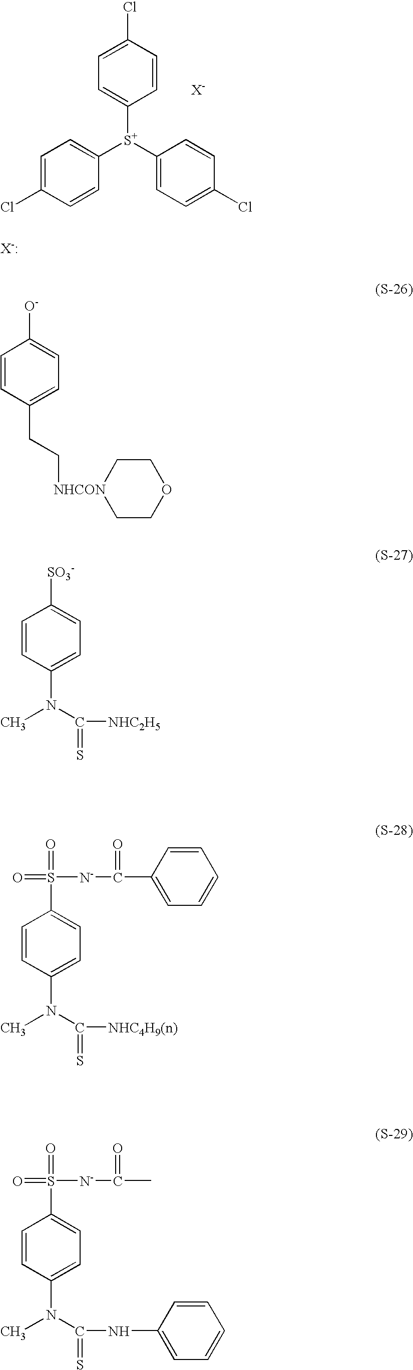

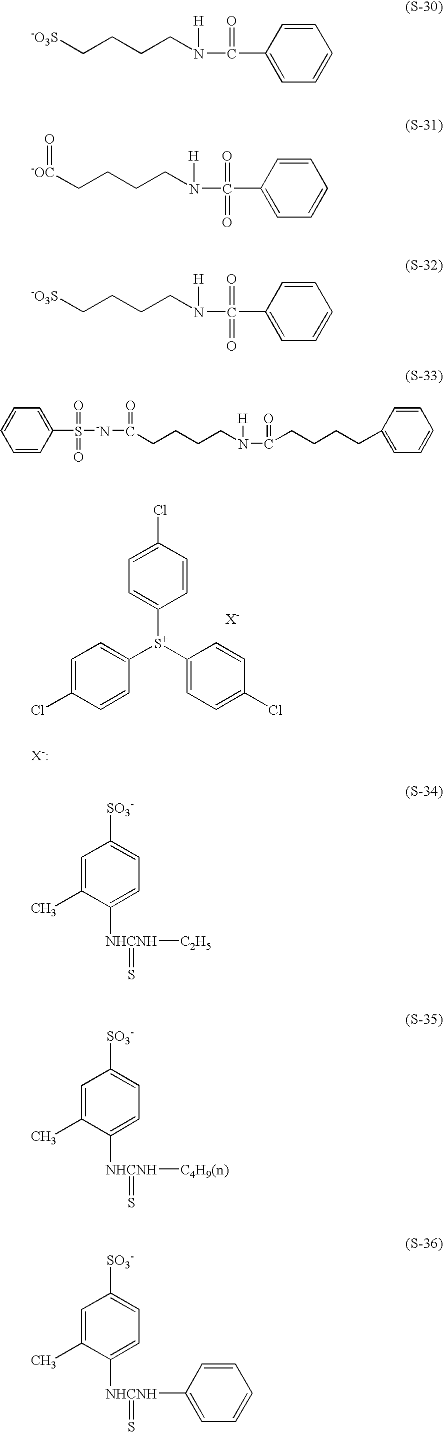

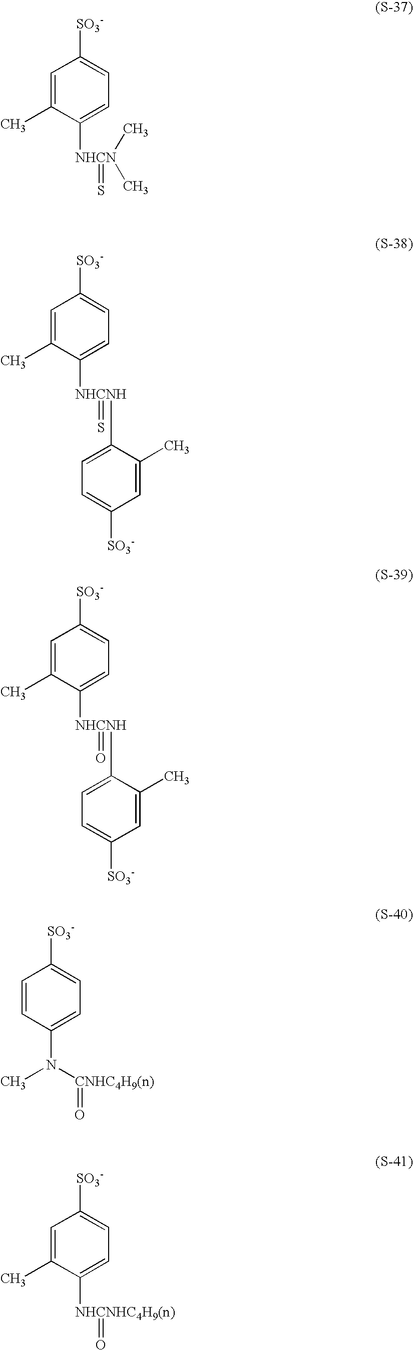

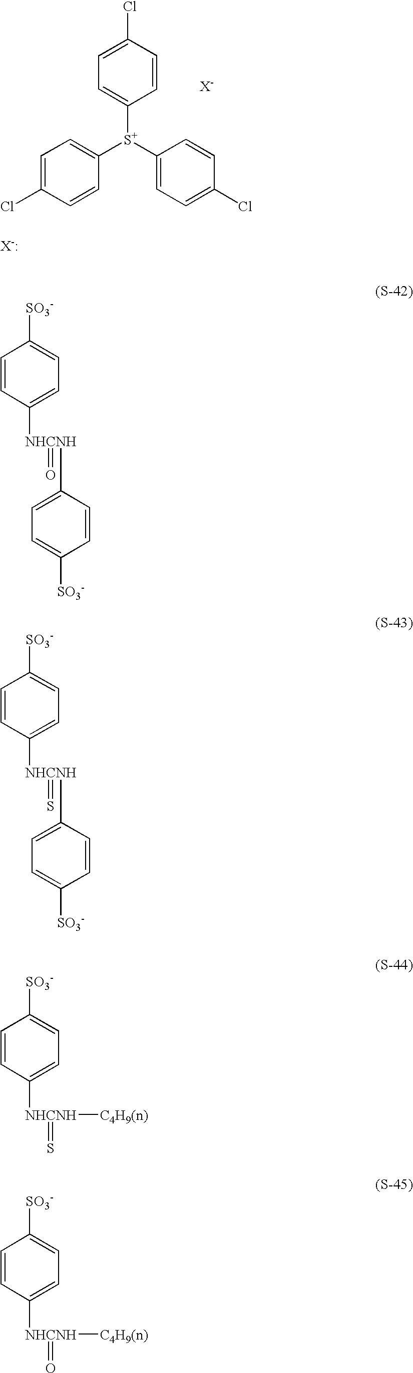

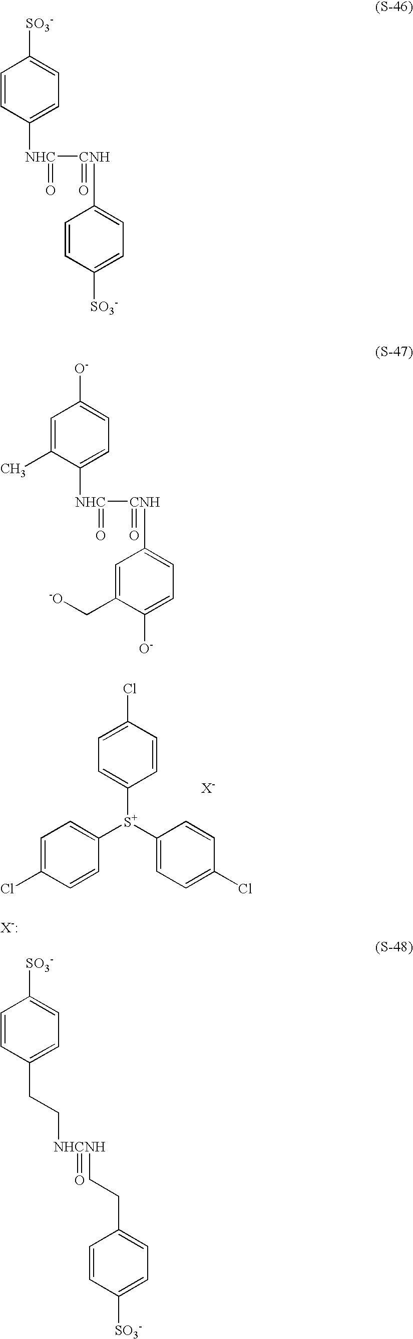

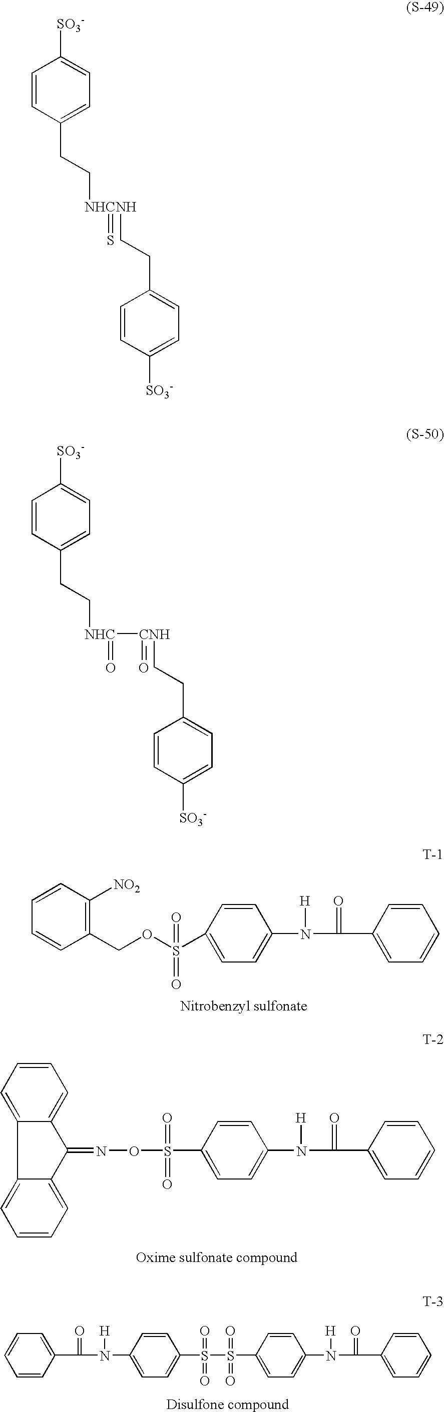

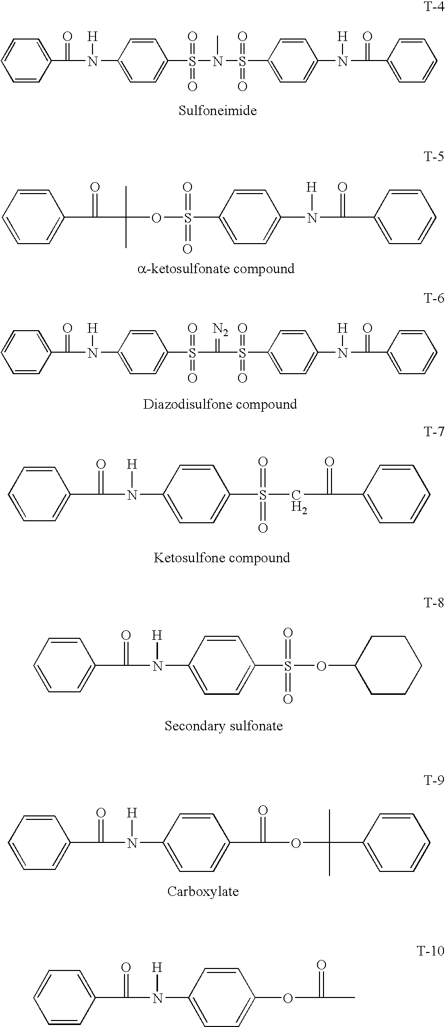

The above specific acid generators (A) may be used either singly or in combinations of two or more.

The amount of these specific acid generators to be compounded is preferably in a range from 0.1 to 50% by weight, more preferably in a range from 0.5 to 40% by weight, and most preferably in a range from I to 30% by weight based on the total solid of the positive photosensitive composition from the viewpoint of the balance between the solubility of an exposed portion in an alkali developer and the resistance to developing of an unexposed portion.

[(B) High-Molecular Compound having a Phenolic Hydroxyl Group]

Examples of the high-molecular compound which has a phenolic hydroxyl group and can be preferably used in the invention include alkali-soluble resins having a phenolic acid group. Specific examples of the high-molecular compound may include novolac resins such as condensation polymers of phenol and formaldehyde, condensation polymers of m-cresol and formaldehyde, condensation polymers of p-cresol and formaldehyde, condensed polymers of m-/p- mixed cresol and formaldehyde and condensation polymers of phenol, cresol (may be any of m-, p-, or m-/p- mixture) and formaldehyde, and condensation polymers of pyrogallol and acetone. Further, copolymers obtained by copolymerizing a compound having a phenol group at its side chain. Or copolymers obtained by copolymerizing compounds having a phenol group at the side chain may be used.

Examples of the compound having a phenol group include acrylamides, methacrylamides, acrylates, methacrylates or hydroxystyrenes having a phenol group.

Among these groups, preferable examples of the compound having a phenol group include novolac resins such as a phenol/formaldehyde resin, an m-cresol/formaldehyde resin, a p-cresol/formaldehyde resin, an m-/p- mixed cresol/formaldehyde resin and a phenol/cresol (may be any of m-, p-, or m-/p- mixture) mixed formaldehyde resin, and a pyrogallol/acetone resin.

Among these groups, more preferable examples of the compound having a phenol group include a novolac-based phenol resin that is mixture of phenol and cresol. The novolac-based phenol resin has phenol as a structural unit in a molecule thereof. The novolac-based phenol resin preferably contains 20 to 90% by mole of phenol as a structural unit with respect to all the structural units consisting the novolac-based phenol resin, more preferably contains 30 to 85% by mole of phenol, and most preferably contains 50 to 80% by mole of phenol. Moreover, it is further preferable that the novolac-based phenol resin further contains 20 to 50% by mole of m-cresol as a structural unit.

Also, as the alkali-soluble resin having phenolic hydroxyl groups, condensed copolymers of phenol and formaldehyde comprising alkyl having 3 to 8 carbon atoms such as tert-butylphenol formaldehyde resin and octylphenol formaldehyde resin as a substituent group can be exemplified as described in U.S. Pat. No. 4,123,279.

The polymer compound having phenolic hydroxyl groups has a weight average molecular weight preferably 500 or higher and more preferably 1,000 to 700,000 in terms of the image formability and has a number average molecular weight preferably 500 or higher and more preferably 750 to 650,000. The dispersion (the weight average molecular weight/the number average molecular weight) is preferably 1.1 to 10.

These alkali-soluble resins are used alone and two or more of them may be used in combination. In the case of combination, as described in U.S. Pat. No. 4,123,279, condensed polymers of phenol comprising alkyl having 3 to 8 carbon atoms as a substituent group and formaldehyde such as condensed polymer of tert-butylphenol and formaldehyde, condensed polymer of octyl phenol and formaldehyde, and as described in Japanese Patent Application Laid-Open No. 2000-241972 previously applied by inventors, alkali-soluble resins having phenol structure having electron attractive group in an aromatic ring may be used in combination.

When the alkali-soluble resin having a phenolic hydroxyl group is used, the amount of the alkali-soluble resin is preferably 30 to 98% by weight, and more preferably 40 to 95% by weight based on the total solid of the composition constituting the photosensitive composition from the viewpoint of sensitivity, image forming ability, and the durability of a coating layer.

Also, in the invention, other alkali-soluble resins may be used together in addition to the high-molecular compound having a phenolic hydroxyl group to the extent that the effect of the invention is not impaired.

[(C) Water-Insoluble and Alkali-Soluble Resin]

It is preferable to use (C) a water-insoluble and an alkali-soluble resin (hereinafter referred to as “alkali-soluble resin” where appropriate) in the photosensitive composition of the invention. The alkali-soluble resin includes homopolymers containing an acid group at each principal chain and/or side chain of the polymers, copolymers of these homopolymers, or mixtures of these polymers.

As other alkali-soluble resins, those having the acid groups given in the following (2) to (6) listed in the explanations of the above acid group at the principal chain and/or side chain of each polymer are preferable from the viewpoint of solubility in an alkali developer and development of dissolution inhibiting ability.

(2) Sulfonamide group (—SO₂NH—R).

(3) Substituted sulfonamide-based acid group (hereinafter referred to as “active amide group”) (SO₂NHCOR, —SO₂NHSO₂R and —CONHSO₂R).

(4) Carboxy group (—CO₂H)

(5) Sulfonic acid group (—SO₃H).

(6) Phosphonic acid group (—PO₃H₂).

In the formulae (2) to (6), Ar represents a divalent aryl connecting group which may have a substituent, and R represents a hydrogen atom or a hydrocarbon group which may have a substituent.

Among these alkali-soluble resins having an acid group selected from the above (2) to (6), alkali-soluble resins having (2) a sulfonamide group or (3) an active imide group are preferable and particularly, alkali-soluble resins having (1) a sulfonamide group are most preferable from the viewpoint of securing solubility to an alkali developer, development latitude and film strength.

Examples of the alkali-soluble resin having an acid group selected from the above (2) to (6) may include the following compounds.

Examples of the a polymer having a sulfonamide group in item (2) include a polymer constituted by a minimum constitutional unit derived from a compound having a sulfonamide group as a main constitutional structural unitcomponent. Examples of such compounds include a compound having one or more of sulfonamide group(s) in which at least one hydrogen atom is bonded to the nitrogen atom, and one or more of polymerizable unsaturated group(s) in the molecule. Among these, a low molecular weight compound comprising an acryloyl group, an allyl group or a vinyloxy group, a substituted or monosubstituted aminosulfonyl group, or a substituted sulfonylimino group in the molecule is preferable. Examples of the compounds includes the compounds represented by the formulas (i) to (v) below.

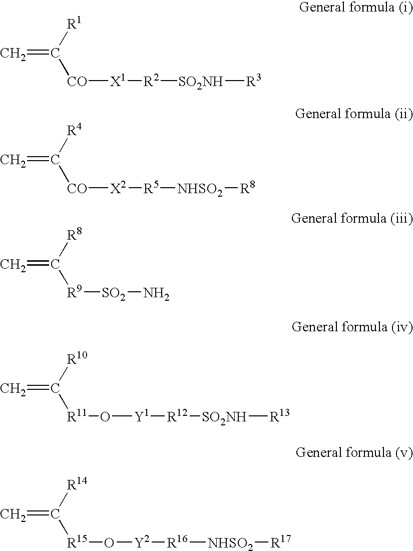

In the general formulae (i) to (v), X¹ and X² each independently represent —O—, or —NR⁷—; R¹ and R⁴ each independently represent a hydrogen atom, or —CH₃; R², R⁵, R⁹, R¹² and R¹⁶ each independently represent an alkylene, cycloalkylene, arylene or aralkylene group which may have a substituent and has 1 to 12 carbon atoms; R³, R⁷ and R¹³ each independently represent a hydrogen atom, or an alkyl, cycloalkyl, aryl or aralkyl group which may have a substituent and has 1 to 12 carbon atoms; R⁶ and R¹⁷ each independently represent an alkyl, cycloalkyl, aryl or aralkyl group which may have a substituent and has 1 to 12 carbon atoms; R⁸, R¹⁰ and R¹⁴ each independently represent a hydrogen atom or —CH₃; R¹¹ and R¹⁵ each independently represent a single bond, or an alkylene, cycloalkylene, arylene or aralkylene group which may have a substituent and has 1 to 12 carbon atoms; and Y¹ and Y² each independently represent a single bond or —CO—.

Among the compounds represented by the formulae (i) to (v), particularly, m-aminosulfonylphenylmethacrylate, N-(p-aminosulfonylphenyl)methacrylamide, N-(p-aminosulfonylphenyl)acrylamide or the like may be preferably used in the positive planographic printing plate precursor.

Examples of the alkali-soluble resin having an active imide group in the item (3) include a polymer having as the main component a minimum structural unit derived from a compound having an active imide group. Examples of such a compound include a compound having in the molecule thereof one or more active imide groups represented by the following structural formula and one or more unsaturated groups which can be polymerized with the active imide group(s):

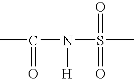

Specifically, N-(p-toluenesulfonyl)methacrylamide, N-(p-toluenesulfonyl)acrylamide and others can be preferably used.

Examples of the monomer having a carboxylic acid group in the item (4) include compounds each having in the molecule thereof one or more carboxylic acid groups and one or more unsaturated groups which can be polymerized with the carboxylic acid group(s).

Examples of the monomer having a sulfonic acid group in the item (5) include compounds each having in the molecule thereof one or more sulfonic acid groups and one or more unsaturated groups which can be polymerized with the sulfonic acid group(s).

Examples of the monomer having a phosphoric acid group in the item (6) include compounds each having in the molecule thereof one or more phosphoric acid group and one or more unsaturated groups which can be polymerized with the phophoric acid group(s).

The minimum constituent unit comprising acidic group selected from (2) to (6), composing an alkali-soluble resin to be used for the positive-type recording layer of the invention, is not necessarily limited to one particular unit, but those obtained by copolymerizing two or more minimum constituent units comprising the same acidic group or two or more minimum constituent units comprising different acidic groups can also be used.

The above-mentioned copolymer contains the compound having the acidic group selected from (2) to (6) to be copolymerized in an amount preferably 10% by mole or more, more preferably 20% by mole or more. If it is less than 10% by mole, the development latitude tends to be improved insufficiently.

When the alkali-soluble resin is used as a copolymer by copolymerizing a compound in the invention, other compounds containing none of the acid groups of the above (2) to (6) may also be used as the compound to be copolymerized. Also, as the above high-molecular compound having a phenolic hydroxide group, copolymer components having no acid group may be likewise used. As examples of these other compounds containing none of the acid groups of the above (2) to (6), the following compounds (m1) to (m12) may be given: however, the invention is not limited to the compounds herein.
(m1) Acrylic acid esters and methacrylic acid esters having aliphatic hydroxyl groups such as 2-hydroxyethyl acrylate or 2-hydroxyethyl methacrylate.
(m2) Alkyl acrylate such as methyl acrylate, ethyl acrylate, propyl acrylate, butyl acrylate, amyl acrylate, hexyl acrylate, octyl acrylate, benzyl acrylate, 2-chloroethyl acrylate, and glycidyl acrylate.
(m3) Alkyl metbacrylate such as methyl methacryl ate, ethyl methacrylate, propyl methacrylate, butyl methacrylate, amyl methacrylate, hexyl methacrylate, cyclohexyl methacrylate, benzyl methacrylate, 2-chloroethyl methacrylate, and glycidyl methacrylate.
(m4) Acrylamide or methacrylamide such as acrylamide, methacrylamide, N-methylol acrylamide, N-ethylacrylamide, N-hexylmethacrylamide, N-cyclohexylacrylamide, N-hydroxyethylacrylamide, N-phenylacrylamide, N-nitrophenylacrylamide, and N-ethyl-N-phenylacxrylamide.
(m5) Vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether.
(m6) Vinyl esters such as vinyl acetate, vinyl chloroacetate, vinyl butylate, and vinyl benzoate.
(m7) Styrenes such as styrene, a-methylstyrene, methylstyrene, and chloromethylstyrene.
(m8) Vinyl ketones such as methyl vinyl ketone, ethyl vinyl ketone, propyl vinyl ketone, and phenyl vinyl ketone.
(m9) Olefins such as ethylene, propylene, isobutylene, butadiene, and isoprene.
(m10) N-vinylpyrrolidone, acrylonitrile, and methacrylonitrile.
(m11) Unsaturated imides such as maleimide, N-acryloylacrylamide, N-acetylmethacrylamide, N-propionylmethacrylamide, and N-(p-chlorobenzoyl)methacrylamide.
(m12) Unsaturated carboxylic acid such as acrylic acid, methacrylic acid, maleic anhydride, and itaconic acid.

Among these the alkali-soluble resin, the positive photosensitive composition of the invention preferably includes an alkali-soluble resin selected from a sulfonicimide-based polymer, a polymer containing a carboxyl group, and a polymer containing a sulfonamide group.

The alkali-soluble resin which can be used in the present invention has a weight average molecular weight preferably 500 or higher and more preferably 1,000 to 700,000 in terms of the image formability and has a number average molecular weight preferably 500 or higher and more preferably 750 to 650,000. The dispersion (the weight average molecular weight/the number average molecular weight) is preferably 1.1 to 10.

When these alkali-soluble resins are used together in the invention, the amount of these alkali-soluble resins is preferably 0 to 30% by weight, and more preferably 0.5 to 20% by weight based on the above high-molecular compound having a phenolic hydroxyl group.

Also, the total amount of the high-molecular compound having a phenolic hydroxyl group and the alkali-soluble resin including these alkali-soluble resins is preferably 40 to 98% by weight, and more preferably 30 to 95% by weight based on the total solid of the photosensitive composition.

[(C) Infrared Absorber]

The positive photosensitive composition of the invention contains (C) an infrared-light absorber.

As the infrared-light absorber (C) used in the invention, any material may be used without any particular limitation insofar as it is a material that absorbs an infrared laser light used for recording to generate heat. However, examples of the infrared-light absorber from the viewpoint of availability and applicability of high-power lasers include infrared-light absorbing dyes or pigments having an absorption maximum at a wavelength of 760 nm to 1200 nm.

[IR Absorbing Dye or Pigment]

As a dye, commercially available dyes and the known dyes described in the publication such as “Dye Handbook” (edited by The Society of Synthetic Organic Chemistry, Japan, published in 1970) can be utilized. Examples include dyes such as azo dyes, metal complex salt azo dyes, pyrazolone azo dyes, naphthoquinone dyes, anthraquinone dyes, phthalocyanine dyes, carbonium dyes, quinoneimine dyes, methine dyes, cyane dyes, squarylium pigments, pyrilium salts, metal thiolate complexes, oxomol dyes, diimonium dyes, aminium dyes, and croconium dyes.

Preferable examples of the dye include cyanine dyes described in JP-A Nos. 58-125246, 59-84356, 59-202829, and 60-78787; methine dyes described in JP-A Nos. 58-173696, 58-181690, and 58-194595; naphthoquinone dyes described in JP-A Nos. 58-112793, 58-224793, 59-48187, 59-73996, 60-52940, and 60-63744; squalirium dyes described in JP-A No. 58-112792; and cyanine dyes described in GB Patent No. 434,875.

Other preferable examples of the dye include near infrared absorbing sensitizers described in U.S. Pat. No. 5,156,938; substituted arylbenzo(thio)pyrylium salts described in U.S. Pat. No. 3,881,924; trimethinethiapyrylium salts described in JP-A No. 57-142645 (U.S. Pat. No. 4,327,169); pyrylium type compounds described in JP-A Nos. 58-181051, 58-220143, 59-41363, 59-84248, 59-84249, 59-146063, and 59-146061; cyanine dyes described in JP-A No. 59-216146; pentarnethinethiopyrylium salts described in U.S. Pat. No. 4,283,475; and pyrylium compounds described in Japanese Patent Application Publication (JP-B) Nos. 5-13514 and 5-19702.

Additional preferable examples of the dye include near infrared absorbing dyes represented by formulae (I) and (II) as described in U.S. Pat. No. 4,756,993.

Among these dyes, particularly preferable are cyanine dyes, phthalocyanine dyes, oxonol dyes, squalirium dyes, pyrylium salts, thiopyrylium dyes, and nickel thiolate complexes.

Moreover, dyes represented by the following formulae (a) to (f) are superior in light-to-heat conversion efficiency and are therefore preferable. Particularly, cyanine dyes represented by the following formula (a) are most preferable because these dyes provide a high interaction with the alkali-soluble resin, function as a dissolution inhibitor, and are superior in stability and economy when used in the invention.

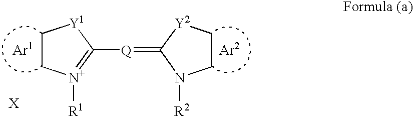

In the formula (a), R¹ and R² respectively represent an alkyl group having 1 to 12 carbon atoms, where the alkyl group may have a substituent selected from an alkoxy group, an aryl group, an amide group, an alkoxycarbonyl group, a hydroxyl group, a sulfo group and a carboxyl group Y¹ and Y² respectively represent oxygen, sulfur, selenium, a dialkylmethylene group or —CH═CH—. Ar¹ and Ar² respectively represent an aromatic hydrocarbon group, which may have a substituent selected from an alkyl group, an alkoxy group, a halogen atom and an alkoxycarbonyl group and may undergo cyclization-condensation of the aromatic ring by the two connecting atoms adjacent to Y¹ or Y².

In the formula (a), X represents a counter ion necessary to neutralize a charge and is not always necessary when the dye cationic part has an anionic substituent. Q represents a polymethine group selected from a trimethine group, a pentamethine group, a heptamethine group, a nonamethine group and an undecamethine group, and is preferably a pentamethine group, a heptamethine group or a nonamethine group from the viewpoint of adaptability to the wavelength of infrared rays used for exposure and stability, and preferably has a cyclohexene ring or a cyclopentene ring containing three methine chains on a carbon atom from the point of stability.

In the formula (a), Q may be substituted with an alkoxy group, an aryloxy group, an alkylthio group, an arylthio group, a dialkylamino group, a diarylamino group, a halogen atom, an alkyl group, an aralkyl group, a cycloalkyl group, an aryl group, an oxy group, an iminium salt group or a group selected from substituents represented by the following formula (i). Preferable examples of the substituent include a halogen atom such as a chlorine atom, a diarylamino group such as a diphenylamino group, and an arylthio group such as a phenylthio group.

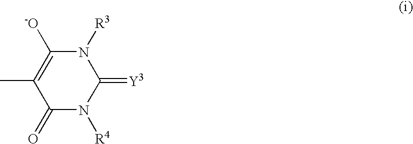

In the formula (i), R³ and R⁴ respectively represents a hydrogen atom, an alkyl group having 1 to 8 carbon atoms, or an aryl group having 6 to 10 carbon atoms. Y³ represents an oxygen atom or a sulfur atom.

Particularly preferable examples of the cyanine dyes among cyanine dyes represented by the formula (a) when exposing to infrared rays having a wavelength range from 800 to 840 nm may include heptamethinecyanine dyes represented by the following formulae (a-1) to (a-4).

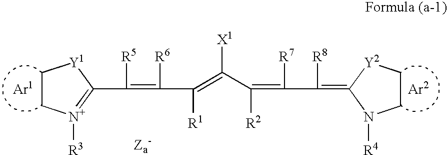

In the formula (a-1), X¹ represents a hydrogen atom or a halogen atom. R¹ and R² respectively represent a hydrocarbon group having 1 to 12 carbon atoms. R¹ and R² respectively preferably a hydrocarbon group having two or more carbon atoms, and more preferably may be combined with each other to form a five- or six-membered ring from the viewpoint of the preserving stability of a recording layer coating solution.

In the formula (a-1), Ar¹ and Ar², which may be the same or different, respectively represent an aromatic hydrocarbon group which may have a substituent. Preferable examples of the aromatic hydrocarbon group include a benzene ring and a naphthalene ring. Also, preferable examples of the substituent include hydrocarbon groups having 12 or less carbon atoms, halogen atoms and alkoxy groups having 12 or less carbon atoms. Y¹ and Y², which may be the same or different, respectively represent a sulfur atom or a dialkylmethylene group having 12 or less carbon atoms. R³ and R⁴, which may be the same or different, respectively represent a hydrocarbon group which has 20 or less carbon atoms and may have a substituent. Preferable examples of the substituent include an alkoxy group having 12 or less carbon atoms, carboxyl groups, and sulfo groups. R⁵, R⁶, R⁷ and R⁸, which may be the same or different, respectively represent a hydrogen atom or a hydrocarbon group having 12 or less carbon atoms. Among these groups, a hydrogen atom is preferable from the viewpoint of availability of raw materials. Also, Za⁺ represents a counter anion necessary to neutralize a charge. When this dye has an anionic substituent in its structure so that it is unnecessary to neutralize a charge, Za⁻ is unnecessary. Preferable examples of Za⁻ include a halogen ion, a perchloric acid ion, a tetrafluoroborate ion, a hexafluorophosphate ion, and a sulfonic acid ion from the viewpoint of the preserving stability of the recording layer coating solution. Particularly preferable examples include a perchloric acid ion, a tetrafluoroborate ion, a hexafluorophosphate ion, and a sulfonic acid ion. The heptamethine dye represented by the formula (a-1) may be preferably used for a positive image forming material and is particularly preferably used for the so-called interaction-release type positive photosensitive material obtained by combination with an alkali-soluble resin having a phenolic hydroxyl group.

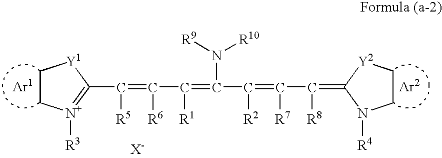

In the formula (a-2), R¹ and R² respectively represent a hydrogen atom or a hydrocarbon group having 1 to 12 carbon atoms, wherein R¹ and R² are combined with each other to form a cyclic structure. The ring to be formed is preferably a five- or six-membered ring, and particularly preferably a five-membered ring. Ar¹ and Ar², which may be the same or different, respectively represent an aromatic hydrocarbon group which may have a substituent. Preferable examples of the aromatic hydrocarbon group include a benzene ring and a naphthalene ring. Also, preferable examples of the substituent on the aromatic hydrocarbon group include hydrocarbon groups having 12 or less carbon atoms, halogen atoms, alkoxy groups having 12 or less carbon atoms, an alkoxycarbonyl group, an alkylsulfonyl group and an alkyl halide group. Electron attractive substituents are particularly preferable. Y¹ and Y², which may be the same or different, respectively represent a sulfur atom or a dialkylmethylene group having 12 or less carbon atoms. R³ and R⁴, which may be the same or different, respectively represent a hydrocarbon group which has 20 or less carbon atoms and may have a substituent. Preferable examples of the substituent include an alkoxy group having 12 or less carbon atoms, carboxyl groups, and sulfo groups. R⁵, R⁶, R⁷ and R⁸, which may be the same or different, respectively represent a hydrogen atom or a hydrocarbon group having 12 or less carbon atoms. Among these groups, a hydrogen atom is preferable from the viewpoint of availability of raw materials. R⁹ and R¹⁰, which may be the same or different, respectively represent an aromatic hydrocarbon group which has 6 to 10 carbon atoms and may have a substituent, an alkyl group having 1 to 8 carbon atoms, or a hydrogen atom, provided that R⁹ and R¹⁰ may be combined with each other to form rings having the following structures.

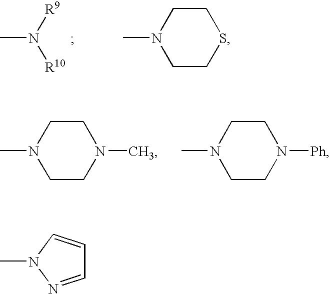

Among the above groups, aromatic hydrocarbon groups are most preferable as R⁹ and R¹⁰ in the formula (a-2).

Also, X⁻ is a counter anion necessary to neutralize a charge and has the same meaning as Za⁻ in the above formula (a-1).

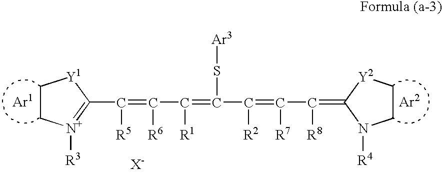

Ar¹, Ar², Y¹, Y² and X⁻ are the same as those in the formula (a-2) respectively. Ar³ represents an aromatic hydrocarbon group such as a phenyl group or a naphthyl group or a monocyclic or polycyclic heterocyclic group having at least one of a nitrogen atom, a oxygen atom, and a sulfur atom. A heterocyclic group selected from the group consisting of a thiazole-based, benzothiazole-based, naphthothiazole-based, thianaphtheno-7,6,4,5-thiazole-based, oxazole-based, benzoxazole-based, naphthoxazole-based, selenazole-based, benzoselenazol-based, naphthoselenazole-based, thiazoline-based, 2-quinoline-based, 4-quinoline-based, 1-isoquinoline-based, 3-isoquinoline-based, benzoimidazole-based, 3,3-dialkylbenzoindolenine-based, 2-pyridine-based, 4-pyridine-based, 3,3-dialkylbenzo[e]indole-based, tetrazole-based, triazole-based, pyrimidine-based and thiadiazole-based group is preferable. Particularly preferable examples of the heterocyclic group include those having the following structures.

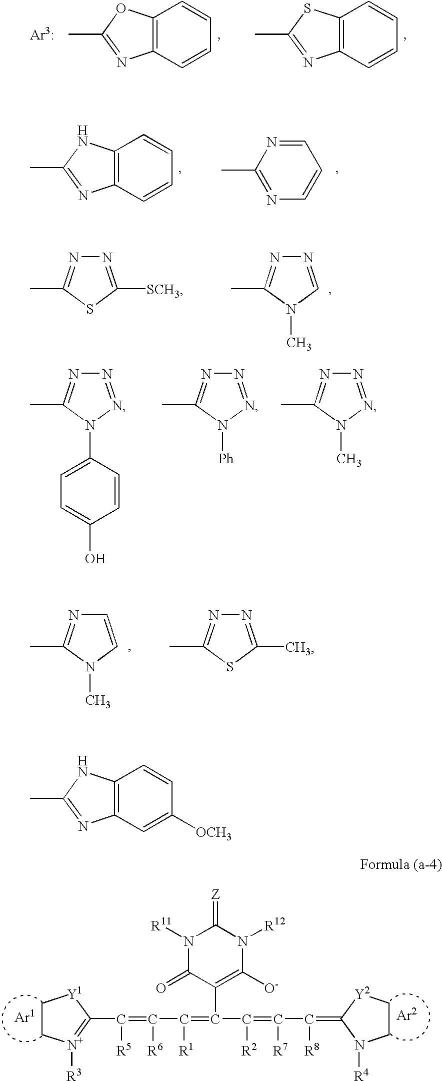

In the formula (a-4), R¹ to R⁸, Ar¹, Ar², Y¹ and Y² have the same meanings as those in the formula (a-2) respectively, R¹ and R², which may be the same or different, respectively represent a hydrogen atom, an allyl group, a cyclohexyl group, or an alkyl group having 1 to 8 carbon atoms. Z represents an oxygen atom or a sulfur atom.

Specific examples of the cyanine dye represented by the formula (a) which may be preferably used in the invention may include, besides examples shown below, those described in JP-A No. 2001-133969, paragraphs [0017] to [0019]; JP-A No. 2002-40638, paragraphs [0012] to [0038]; and JP-A No. 2002-23360, paragraphs [0012] to [0023].

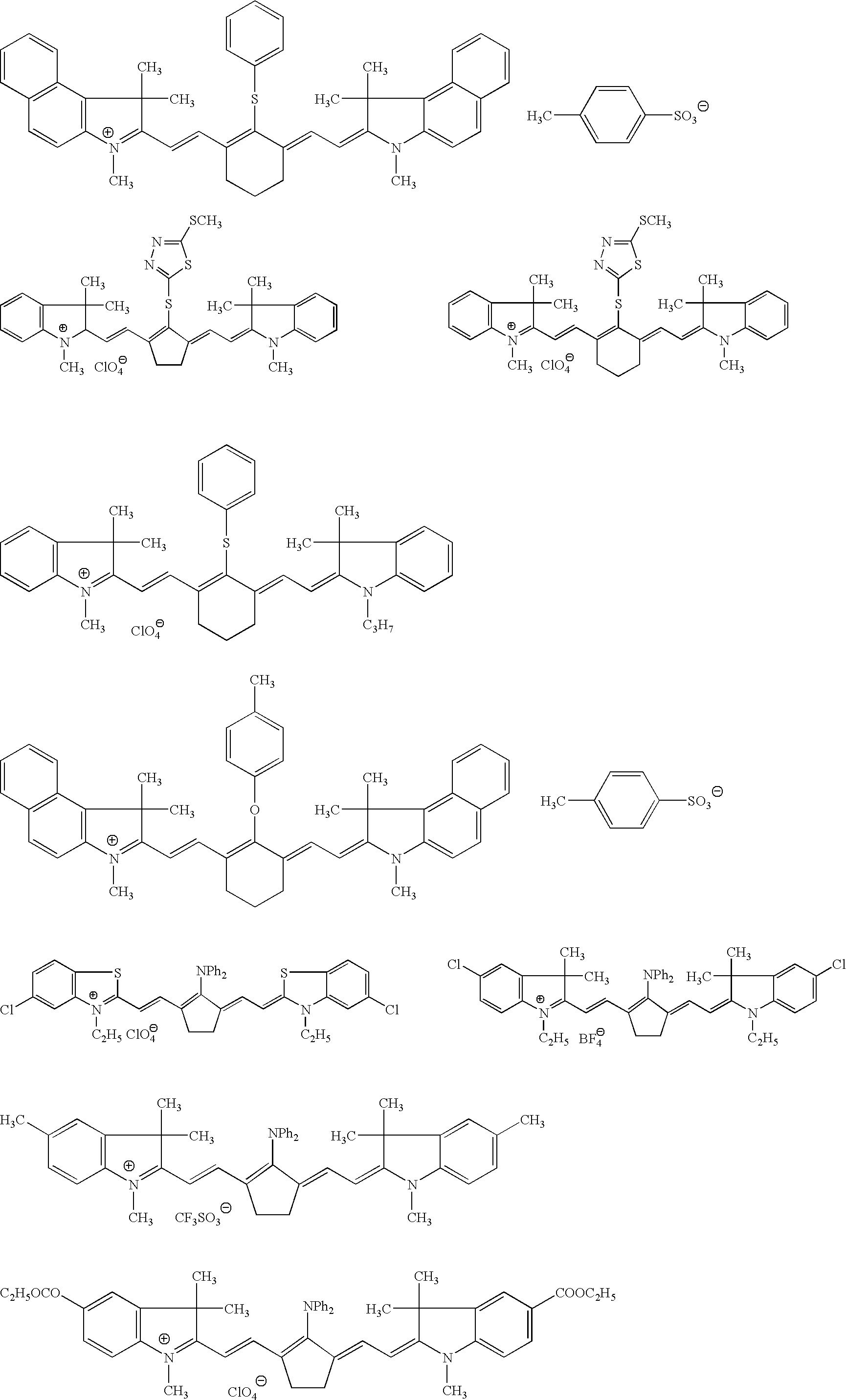

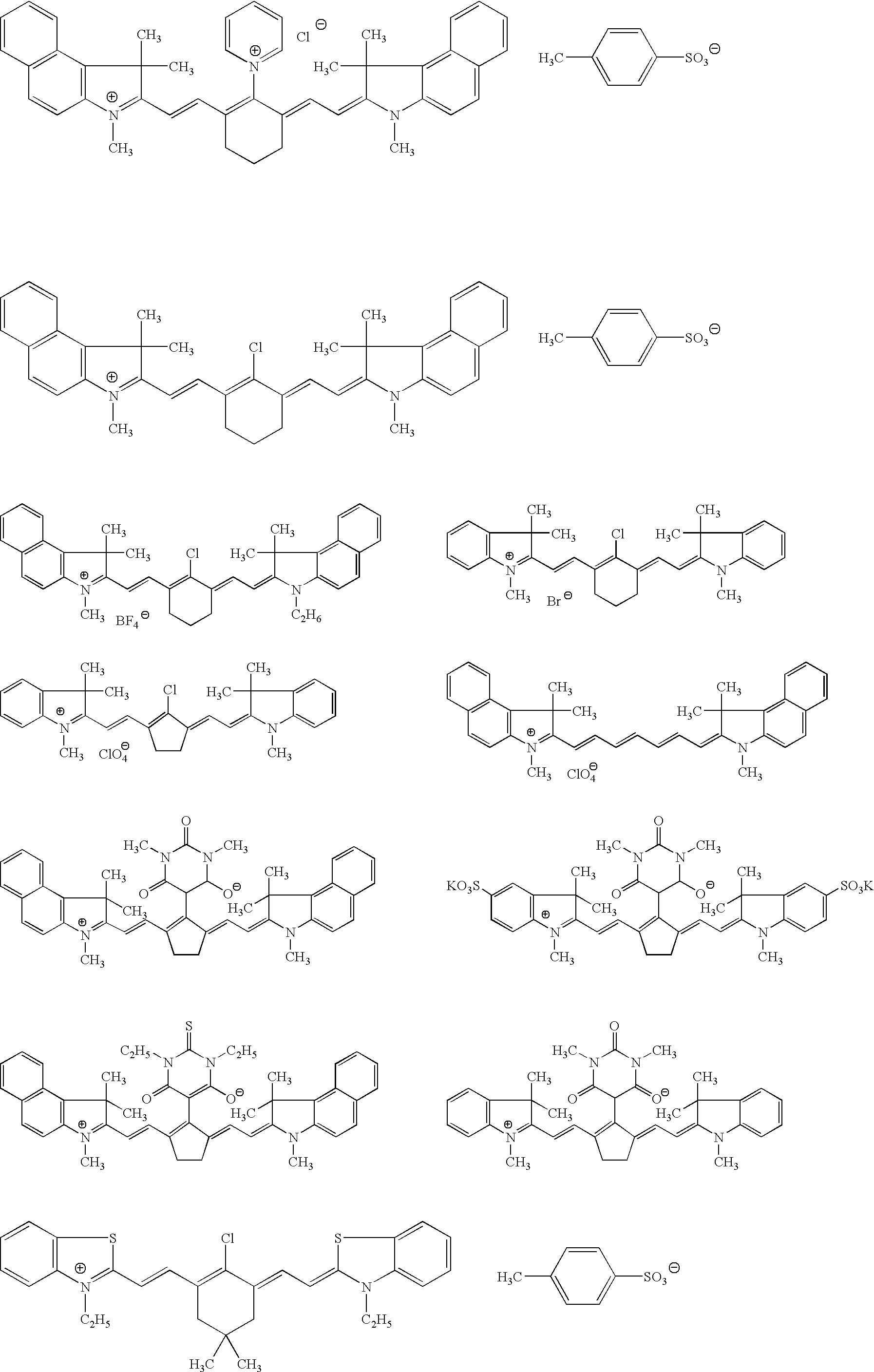

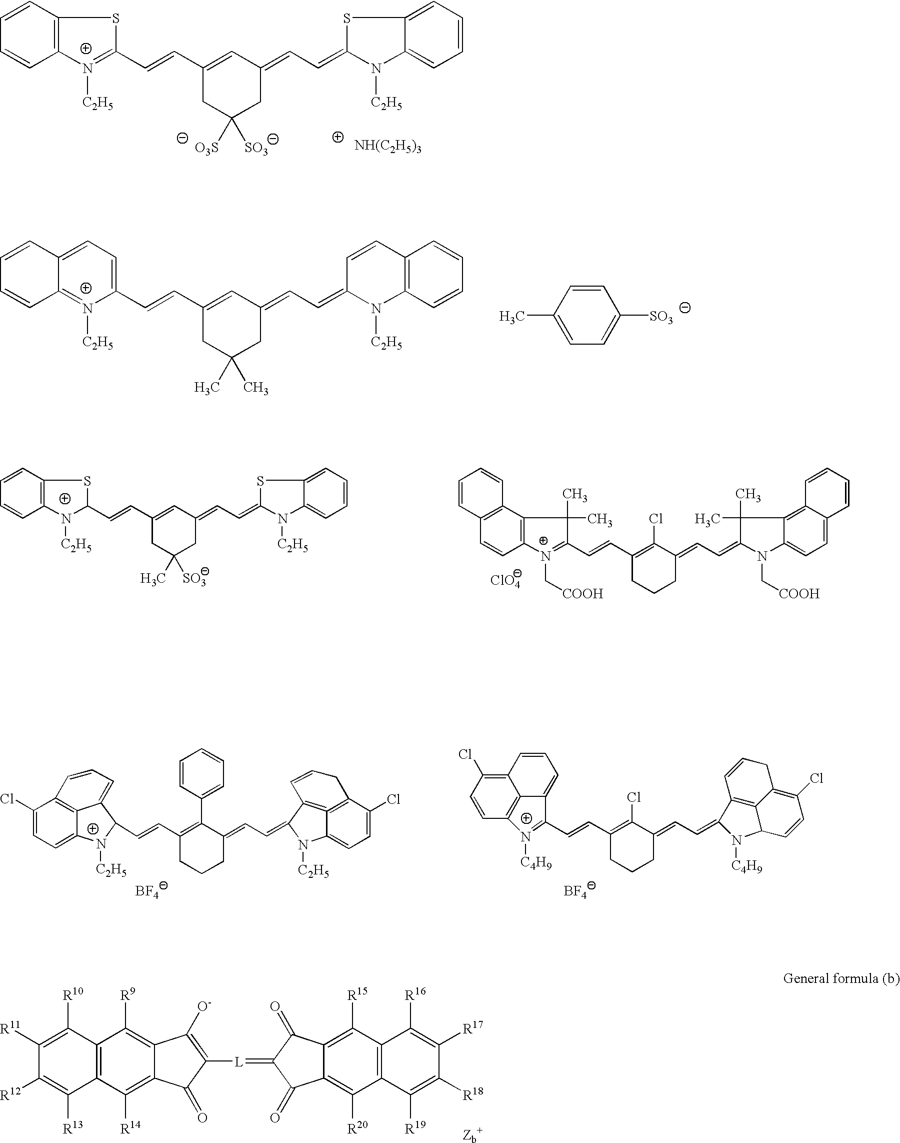

In general formula (b), L represents a methine chain having 7 or more conjugated carbon atoms, and the methine chain may have one or more substituent. The substituents may be bonded to each other to form a cyclic structure. Zb⁺ represents a counter cation. Preferable examples of the counter cation include ammonium, iodonium, sulfonium, phosphonium and pyridinium ions, and alkali metal cations (such as Ni⁺, K⁺ and Li⁺).

R⁹ to R¹⁴ and R¹⁵ to R²⁰ each independently represents a substituent selected from hydrogen atom, halogen atom, and cyano, alkyl, aryl, alkenyl, alkynyl, carbonyl, thio, sulfonyl, sulfinyl, oxy and amino groups; or a substituent obtained by combining two or three from among these substituents. Two or three out of R⁹ to R¹⁴ and R¹⁵ to R²⁰ may be bonded to each other to form a cyclic structure.

A dye wherein L in general formula (b) represents a methine chain having 7 conjugated carbon atoms, and each of R⁹ to R¹⁴ and R¹⁵ to R²⁰ represents a hydrogen atom, is preferable since such dye can be easily obtained and exhibits advantageous effects.

Specific examples of the dye represented by general formula (b), and which can be preferably used in the invention, are illustrated below.

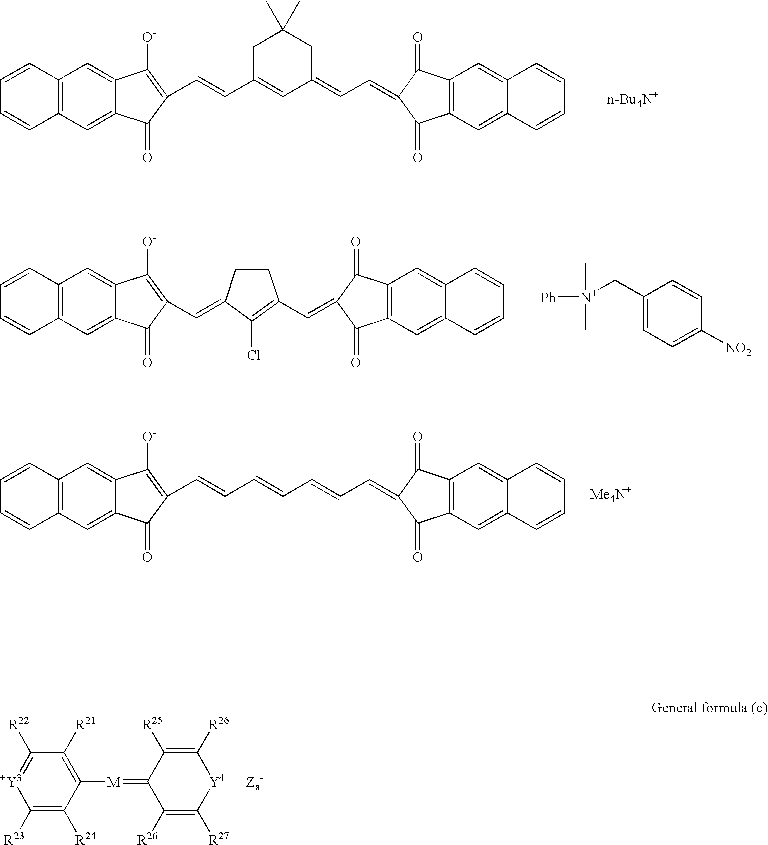

In general formula (c), Y³ and Y⁴ each independently represent an oxygen, sulfur, selenium or tellurium atom; M represents a methine chain having 5 or more conjugated carbon atoms; R²¹ to R²⁴ and R²⁵ to R²⁸, which may be the same or different, each represents a hydrogen or halogen atom, or a cyano, alkyl, aryl, alkenyl, alkynyl, carbonyl, thio, sulfonyl, sulfinyl, oxy or amino group; and Za⁻ represents a counter anion, and has the same meaning as Za⁻ in general formula (a-1).

Specific examples of the dye which is represented by general formula (c) and which can be preferably used in the invention, are illustrated below.

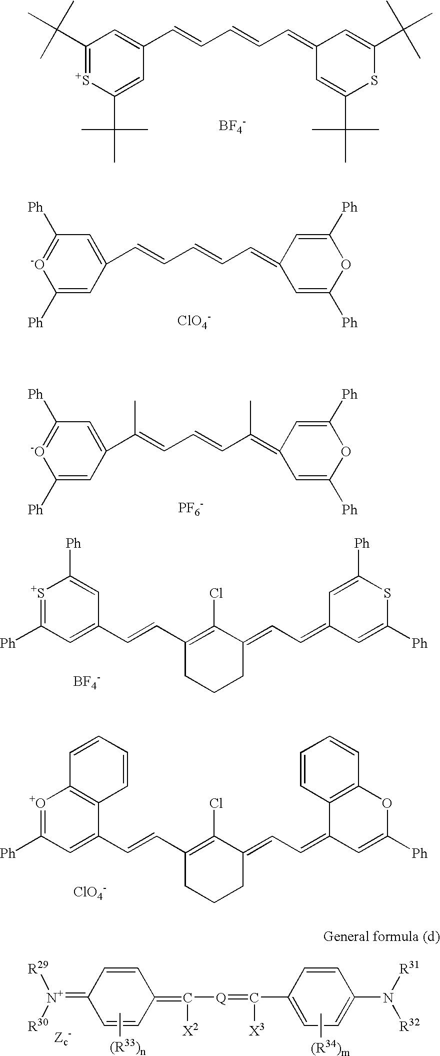

In general formula (d), R²⁹ to R³¹ each independently represents a hydrogen atom, an alkyl group or an aryl group; R³³ and R³⁴ each independently represents an alkyl group, a substituted oxy group, or a halogen atom; n and m each independently represents an integer of 0 to 4; and R²⁹ and R³⁰, or R³¹ and R³² may be bonded to each other to form a ring, or R²⁹ and/or R³⁰ may be bonded to R³³ to form a ring and R³¹ and/or R³² may be bonded to R³⁴ to form a ring. When plural R³³'s and R³⁴'s are present, R³³'s may be bonded to each other to form a ring, or R³⁴'s may be bonded to each other to form a ring.

X² and X³ each independently represents a hydrogen atom, an alkyl group or an aryl group, and at least one of X² and X³ represents a hydrogen atom or an alkyl group.

Q represents a trimethine group or a pemamethine group which may have a substituent, and may be combined with an bivalent linking group to form a cyclic structure. Zc⁻ represents a counter anion and has the same meanings as Za⁻ in general formula (a).

Specific examples of the dye represented by general formula (d) and which can be preferably used in the invention, are illustrated below.

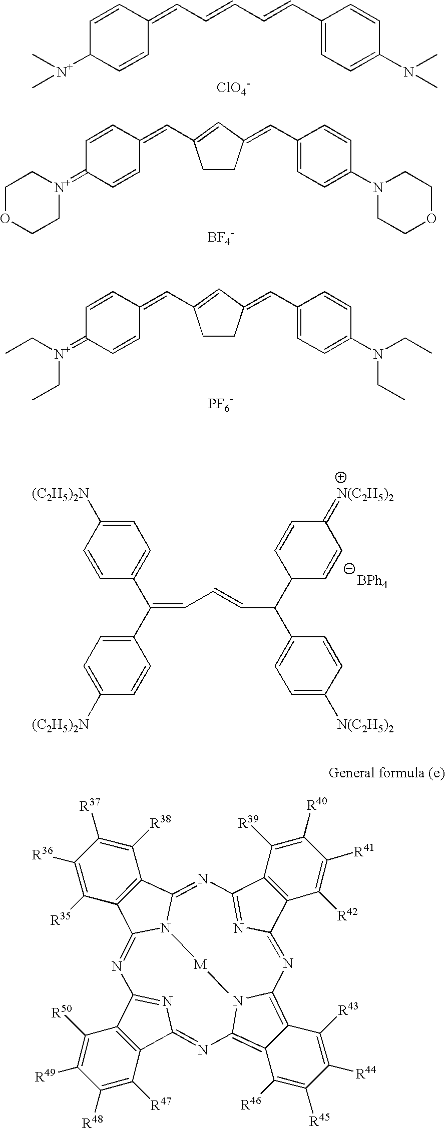

In general formula (e), R³⁵ to R⁵⁰ each independently represents a hydrogen or halogen atom, or a cyano, alkyl, aryl, alkenyl, alkynyl, hydroxyl, carbonyl, thio, sulfonyl, sulfinyl, oxy or amino group, or an onium salt structure, each of which may have a substituent; M represents two hydrogen atoms, a metal atom, a halo metal group, or an oxy metal group. Examples of the metal contained therein include atoms in IA, IIA, IIIB and IVB groups in the periodic table, transition metals in the first, second and third periods therein, and lanthanoid elements. Among these examples, preferable are copper, magnesium, iron, zinc, cobalt, aluminum, titanium, and vanadium. In formula (e), vanadium, nickel, zinc and tin are particularly preferable as M. These metals may be combined with an oxygen atom, a halogen atom or the like to make these metal atoms each have an appropriate valence.

Specific examples of the dye represented by general formula (e) and which can be preferably used in the invention, are illustrated below.

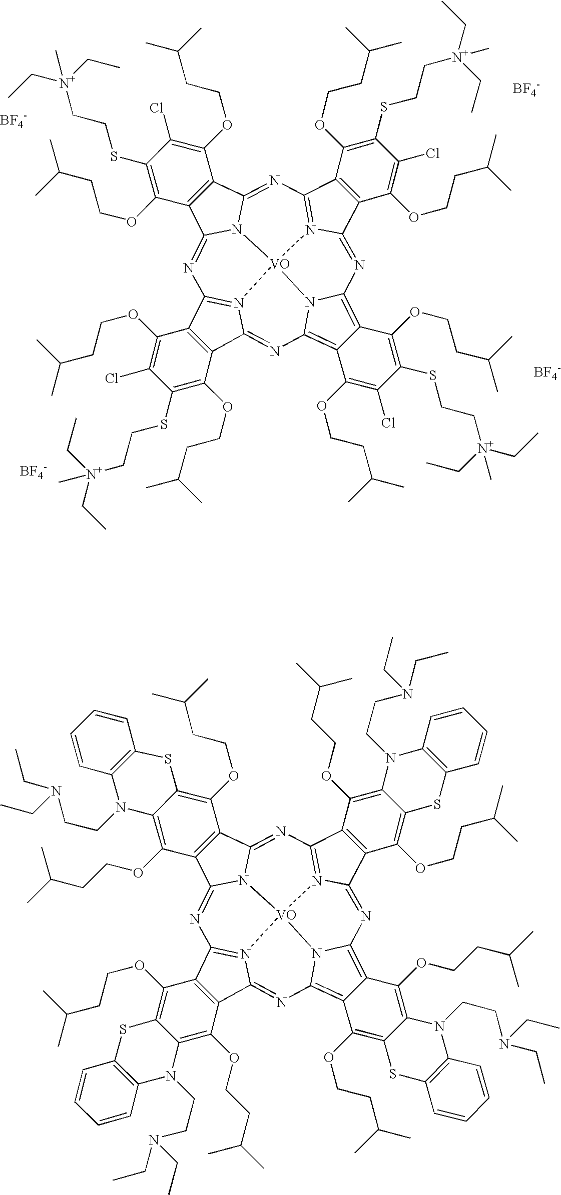

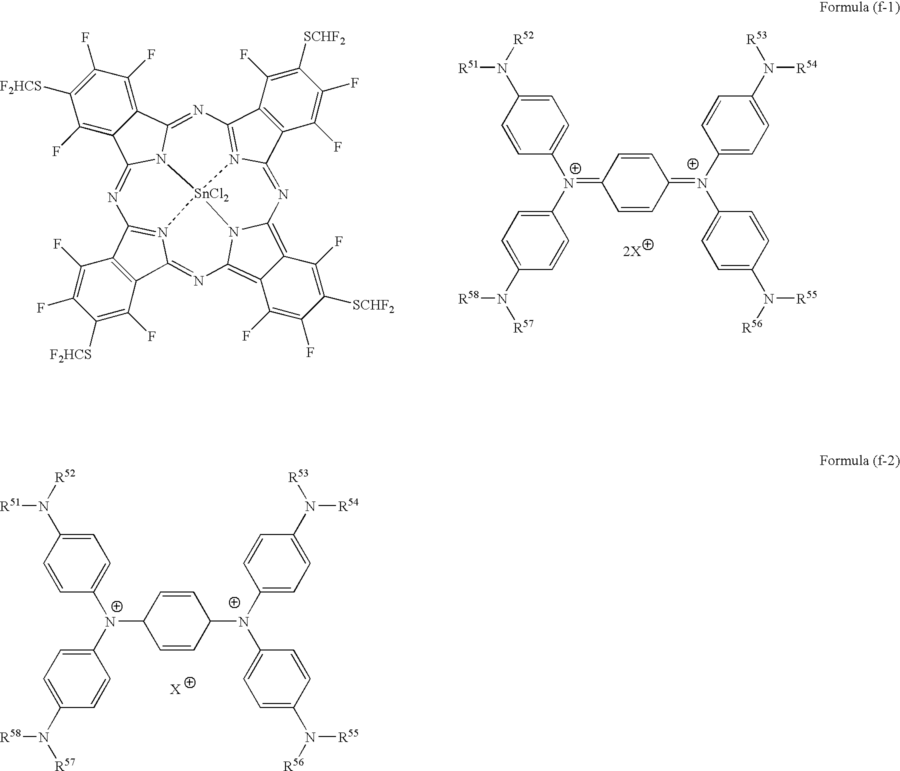

In the formulae (f-1) and (f-2), R⁵¹ to R⁵⁸ respectively represent a hydrogen atom, or an alkyl or aryl group which may have a substituent. X⁻ has the same meanings as that in the above formula (a-2).

Specific examples of the dyes which may be preferably used and represented by the formulae (f-1) or (f-2) may include those given below.

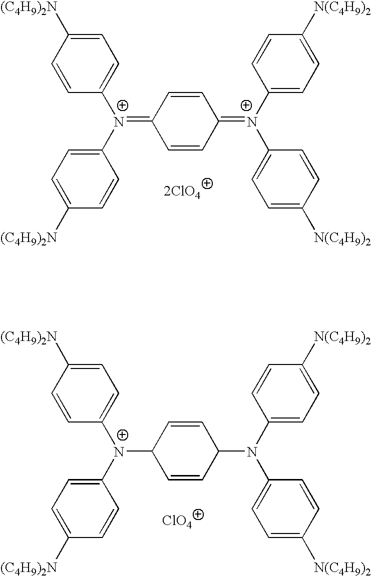

As the light-to-heat converter other than the above, for example, dyes having plural chromophores as described in JP-A No. 2001-242613, dyes of which the chromophore is connected to a high-molecular compound as described in JP-A No. 2002-97384 and U.S. Pat. No. 6,124,425, anionic dyes as described in U.S. Pat. No. 6,248,893, and dyes having a surface orientation group as described in JP-A No. 2001-347765 may be preferably used.

The pigment used as the infrared absorbent in the invention may be a commercially available pigment or a pigment described in publications such as Color Index (C.I.) Handbook, “Latest Pigment Handbook” (edited by Japan Pigment Technique Association, and published in 1977), “Latest Pigment Applied Technique” (by CMC Publishing Co., Ltd. in 1986), and “Printing Ink Technique” (by CMC Publishing Co., Ltd. in 1984).

Examples of the pigment include black pigments, yellow pigments, orange pigments, brown pigments, red pigments, purple pigments, blue pigments, green pigments, fluorescent pigments, metal powder pigments, and polymer-bonded dyes. Specifically, the following can be used: insoluble azo pigments, azo lake pigments, condensed azo pigments, chelate azo pigments, phthalocyanine pigments, anthraquinone pigments, perylene and perynone pigments, thioindigo pigments, quinacridone pigments, dioxazine pigments, isoindolinone pigments, quinophthalone pigments, dyeing lake pigments, azine pigments, nitroso pigments nitro pigments, natural pigments, fluorescent pigments, inorganic pigments, and carbon black. Among these pigments, carbon black is preferable.

These pigments may be used with or without surface treatment. Examples of surface treatment include a method of coating the surface of the pigments with resin or wax; a method of adhering a surfactant onto the surface; and a method of bonding a reactive material (such as a silane coupling agent, an epoxy compound, or a polyisocyanate) to the pigment surface. The surface treatment methods are described in “Nature and Application of Metal Soap” (Saiwai Shobo), “Printing Ink Technique” (by CMC Publishing Co., Ltd. in 1984). And “Latest Pigment Applied Technique” (by CMC Publishing Co., Ltd. in 1986.

A particle diameter of a pigment is preferably in a range of 0.01 μm to 10 μm, further preferably in a range of 0.05 μm to 1 μm, particularly preferably in a range of 0.1 =82 m to 1 μm.

The method for dispersing the pigment may be a known dispersing technique used to produce ink or toner. Examples of a dispersing machine, which can be used, include an ultrasonic disperser, a sand mill, an attriter, a pearl mill, a super mill, a ball mill, an impeller, a disperser, a KD mill, a colloid mill, a dynatron, a three-roll mill, and a pressing kneader. Details are described in “Latest Pigment Applied Technique” (by CMC Publishing Co., Ltd. in 1986).

These dyes or pigments may be used either singly or in combinations of two or more.

These pigments or dyes may be added in an amount of 0.01 to 50% by weight, preferably 0.1 to 10% by weight, and particularly preferably 0.5 to 10% by weight in the case of a dye or 0.1 to 10% by weight in the case of a pigment based on the total content of the solid constituting the recording layer from the viewpoint of the balance between sensitivity, stability, and uniformity.

(Other Components)

The photosensitive composition of the invention may be further compounded of various additives according to the need.

It is preferable to combine materials, such as an o-quinonediazide compound, an aromatic sulfonic compound, or an aromatic sulfonate compound, which is thermally decomposable and substantially decreases the solubility of the aqueous alkali-soluble high-molecular compound when these materials are in a non-decomposed state with the view of improving the ability to inhibit the dissolution of an image portion in a developer.

As the quinone diazide compounds, o-quinone diazide compounds are preferable. The o-quinone diazide compound for use in the invention is, for example, a compound having at least one o-quinone diazide group that becomes more alkali soluble by thermal decomposition, and such compounds in various structures may be used. Namely, such an o-quinone diazide makes the photosensitive system more soluble when it reduces the solubilization-inhibiting potential thereof with respect to the binder and is modified to be alkali-soluble by itself as a result of thermal decomposition. Examples of the o-quinone diazide compounds for use in the invention include the compounds described on pp. 339 to 352 of “Light Sensitive Systems” (J. Corsair Ed., John Wiley & Sons. Inc.), and in particular, sulfonic esters or sulfonic acid amides of the o-quinone diazides, which are prepared in reaction with various aromatic polyhydroxy compounds or aromatic amino compounds, are favorable. In addition, the esters from benzoquinone-(1,2)-diazido-sulfonylchloride or naphthoquinone-(1,2)-diazido-5-sulfonylchloride and a pyrogallol-acetone resin described in JP-B No. 43-28403, and the esters from benzoquinone-(1,2)-diazido-sulfonylchloride or naphtboquinone-(1,2)-diazido-5-sulfonylchloride and a phenol-formaldehyde resin described in U.S. Pat. Nos. 3,046,120 and 3,188,210 are also favorably used.

Additional preferable examples include an ester made from naphthoquinone-(1,2)-diazide-4-sulfonic acid chloride and phenol-formaldehyde resin or cresol-formaldehyde resin; and an ester made from naphthoquinone-(1,2)-diazide-4-sulfonic acid chloride and pyrogallol-acetone resin.

Other useful o-quinonediazide compounds are reported in unexamined or examined patent documents, examples of which include JP-A Nos. 47-5303, 48-63802, 48-63803, 48-96575, 49-38701 and 48-13354, JP-B No. 41-11222, 45-9610 and 49-17481, U.S. Pat. Nos. 2,797,213, 3,454,400, 3,544,323, 3,573,917, 3,674,495 and 3,785,825, GB Patent Nos. 1,227,602, 1,251,345, 1,267,005, 1,329,888 and 1,330,932, and DE Patent No. 854,890.

The amount of the o-quinone diazide compound added is preferably in the range of 1 to 50%, still more preferably 5 to 30%, and particularly preferably 10 to 30% by weight with respect to the total solid matters in photosensitive composition.

These o-quinone diazide compounds may be used alone or as a mixture of several compounds.

The amount of the additives other than o-quinonediazide compound is preferably 1 to 50% by weight, more preferably 5 to 30% by weight, and particularly preferably 10 to 30% by weight based on the total solid of the image forming material. The additives and binder in the invention are preferably contained in the same layer.

In order to enhance sensitivity, the photosensitive composition may also contain a cyclic acid anhydride, a phenolic compound, or an organic acid.

Examples of cyclic acid anhydride include phthalic anhydride, tetrahydrophthalic anhydride, hexahydrophthalic anhydride, 3,6-endooxy-Δ4-tetrahydrophthalic anhydride, tetrachlorophthalic anhydride, maleic anhydride, chloromaleic anhydride, α-phenylmaleic anhydride, succinic anhydride, and pyromellitic anhydride which are described in U.S. Pat. No 4,115,128.

Examples of phenolic compound include bisphenol A, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, 4,4′,3″,4″-tetrahydroxy-3,5,3′,5′-tetramethyltriphenylmethane.

Examples of the organic acid include sulfonic acids, sulfonic acids, alkylsulfuric acids, phosphonic acids, phosphates, and carboxylic acids, which are described in JP-A No. 60-88942 or 2-96755. Specific examples thereof include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid, and ascorbic acid.

When the cyclic acid anhydride, the phenol or the organic acid is added to a recording layer of a planographic printing plate precursor, the ratio thereof in the recording layer is preferably from 0.05 to 20%, more preferably from 0.1 to 15%, and even more preferably from 0.1 to 10% by mass.

When the photosensitive composition according to the invention is used in a recording layer of a planographic printing plate precursor, in order to enhance stability in processes which affect conditions of developing, the following can be added; nonionic surfactants as described in JP-A Nos. 62-251740 and 3-208514; amphoteric surfactants as described in JP-A Nos. 59-121044 and 4-13149; siloxane compounds as described in EP No. 950517; and copolymers made from a fluorine-containing monomer as described in JP-A No. 11-288093.

Specific examples of nonionic surfactants include sorbitan tristearate, sorbitan monopalmitate, sorbitan trioleate, monoglyceride stearate, and polyoxyethylene nonyl phenyl ether. Specific examples of amphoteric surfactants include alkyldi(aminoethyl)glycine, alkylpolyaminoethylglycine hydrochloride, 2-alkyl-N-carboxyethyl-N-hydroxyethylimidazolinium betaine and N-tetradecyl-N,N′-betaine type surfactants (trade name: “Amolgen K”, manufactured by Dai-ichi Kogyo Seiyaku Co., Ltd.).

The siloxane compounds are preferably block copolymers made from dimethylsiloxane and polyalkylene oxide. Specific examples thereof include polyalkylene oxide modified silicones (trade names: DBE-224, DBE-621, DBE-712, DBE-732, and DBE-534, manufactured by Chisso Corporation; trade name: Tego Glide 100, manufactured by Tego Co., Ltd.).

The content of the nonionic surfactant and/or the amphoteric surfactant in the image forming material is preferably from 0.05 to 15% by mass, and more preferably from 0.1 to 5% by mass.

To the photosensitive composition of the invention may be added a printing-out agent for obtaining a visible image immediately after the photosensitive composition of the invention has been heated by exposure to light, or a dye or pigment as an image coloring agent.

A typical example of a printing-out agent is a combination of a compound which is heated by exposure to light, thereby emitting an acid (an optically acid-generating agent), and an organic dye which can form salts (salt formable organic dye).

Specific examples thereof include combinations of an o-naphthoquinonediazide-4-sulfonic acid halogenide with a salt-formable organic dye, described in JP-A Nos. 50-36209 and 53-8128; and combinations of a trihalomethyl compound with a salt-formable organic dye, described in each of JP-A Nos. 53-36223, 54-74728, 60-3626, 61-143748, 61-151644 and 63-58440.

The trihalomethyl compound is classified into an oxazol compound or a triazine compound. Both of the compounds provide excellent in stability over the passage of time and produce a vivid printed-out image.

As the image coloring agent, a dye different from the above-mentioned salt-formable organic dye may be used. Preferable examples of such a dye, and of the salt-formable organic dye, include oil-soluble dyes and basic dyes.

Specific examples thereof include Oil yellow #101, Oil Yellow #103, Oil Pink #312, Oil Green BG; Oil Blue BOS, Oil Blue #603, Oil Black BY, Oil Black BS, and Oil Black T-505 (each of which is manufactured by Orient Chemical Industries Ltd.); Victoria Pure Blue, Crystal Violet (C142555), Methyl Violet (CI42535), Ethyl Violet, Rhodamine B (CI145170B), Malachite Green (CI42000), and Methylene Blue (CI52015).

Dyes described in JP-A No. 62-293247 are particularly preferable. These dyes may be added to the photosensitive composition at a ratio of 0.01 to 10% by mass, and preferably 0.1 to 3% by mass, relative to the total solid contents therein.

Whenever necessary, a plasticizer may be added to the photosensitive composition of the invention to give flexibility to a coating film made from the composition. Examples of the plasticizer include oligomers and polymers of butyl phthalyl, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl olete, and acrylic acid and methacrylic acid.

In addition to the above, the following may be appropriately added to the composition, depending on the objective: an epoxy compound; a vinyl ether; a phenol compound having a hydroxymethyl group and a phenol compound having an alkoxymethyl group, described in JP-A No. 8-276558; and a cross-linkable compound having an effect of suppressing dissolution in an alkali, described in JP-A No. 11-160860, and which was previously proposed by the present inventors.

The photosensitive composition of the invention may be applied to various uses such as planographic printing plate precursors, color proofs, and display materials by applying it to an appropriate support to form a photosensitive layer, and is particularly useful for a recording layer in a planographic printing plate precursor which enables direct plate-making by infrared laser light exposure and applicable to a heat mode. The photosensitive composition of the invention will be explained in detail taking, as an example, the case where the composition is used for a recording layer in a planographic printing plate precursor.

[Planographic Printing Plate Precursor]

Specific embodiment of the photosensitive composition of the invention will be explained in detail taking, as an example, the case where the composition is applied to a recording layer in a planographic printing plate precursor.

(Recording Layer (Image Forming Layer))

When the photosensitive composition is used as a recording layer of a planographic printing plate precursor, the coating solution components of the composition may be dissolved in a solvent, which is then applied to a proper support to form the recording layer. Also, a protective layer, a resin intermediate layer, a backcoat layer and the like may be formed in the same manner according to the need.

Examples of the solvent in this case include ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetoamide, N,N-dimethylformamide, tetramethylurea, N-methylpyrrolidone, dimethylsulfoxide, sulfolane, y-butyrolactone, and toluene. However, the solvent is not limited thereto. Moreover, these solvents may be used alone, or in a mixture form.

The concentration of the components for recording layer in the solvent (all solid matters including additives) is preferably 1 to 50% by weight.

The amount of the coat on the support obtained after application and drying (solid matter) may vary according to applications, but is generally, preferably 0.5 to 5.0 g/m² in the case of the recording layer for planographic printing plate precursors. Decrease in the coating amount leads to apparent increase in sensitivity but also to deterioration in the film properties of image-forming layer.

The recording layer may be a single layer or a layer in the multilayer structure.

Various coating methods, for example, including bar coater coating, spin coating, spray coating, curtain coating, dip coating, air knife coating, blade coating, roll coating, and the like, may be used as the coating method.

In the recording layer of the invention, a surfactant for improvement in coating property, for example, one of the fluorochemical surfactants described in JP-A No. 62-170950, may be added. The preferable addition amount is 0.01 to 1% and still more preferably 0.05 to 0.5% by weight with respect to the total solid matters.

(Resin Intermediate Layer)

In the planographic printing plate precursor, a resin intermediate layer may be interposed between the recording layer and the support according to the need.

The provision of this resin intermediate layer has a merit that because the recording layer, which is an infrared ray-sensitive layer that improves in solubility to an alkali developer by exposure to light, is located on or in the vicinity of the exposed surface, the precursor has improved sensitivity to an infrared laser, and that because the resin intermediate layer exists between the support and the infrared ray-sensitive layer and functions as an insulating layer, the heat generated by the exposure to the infrared laser is not diffused into the support and is used for efficient image formation, bringing about high sensitization.

In unexposed portions of the recording layer, the recording layer itself, which the alkali developer does not penetrate, functions as a protective layer for the resin intermediate layer. Accordingly, development stability of the printing plate precursor is secured to a satisfactory level and, in addition, images superior in discrimination are formed. Moreover, it is believed that over the passage of time of the images can be maintained.

On the other hand, in the exposed portions, components of the recording layer, the dissolution-suppressing function of which has been nullified, are speedily dissolved and dispersed into the developer, and, further, the resin intermediate layer, which is positioned adjacent to the support, is made mainly of an alkali-soluble resin. Accordingly, the exposed portions exhibit satisfactory solubility in the developer. Therefore, for example, even when a developer whose activity has been lowered is used, the intermediate resin layer is rapidly dissolved without leaving any portion of the layer remaining behind. This fact contributes to an improvement in the developability of the printing plate precursor, and in this way the resin intermediate layer is useful.

[Support]

The support used in the planographic printing plate precursor is a plate having dimensional stability. A plate satisfying required physical properties such as strength and flexibility can be used without any restriction. Examples thereof include paper, plastic (such as polyethylene, polypropylene or polystyrene)-laminated papers, metal plates (such as aluminum, zinc and copper plates), plastic films (such as cellulose biacetate, cellulose triacetate, cellulose propionate, cellulose lactate, cellulose acetate lactate, cellulose nitrate, polyethylene terephthalate, polyethylene, polystyrene, polypropylene, polycarbonate, and polyvinyl acetate films), and papers or plastic films on which, as described above, a metal is laminated or vapor-deposited.

The support is, when used for a planographic printing plate precursor, preferably a polyester film or an aluminum plate, and more preferably an aluminum plate, since an aluminum plate is superior in terms of dimensional stability and is also relatively inexpensive.

Preferable examples of the aluminum plate include a pure aluminum plate and alloy plates made of aluminum as a main component with a very small amount of other elements. A plastic film on which aluminum is laminated or vapor-deposited may also be used.

Examples of other elements contained in the aluminum alloys include silicon, iron, manganese, copper, magnesium, chromium, zinc, bismuth, nickel, and titanium. The content by percentage of different elements in the alloy is at most 10% by mass. A particularly preferable aluminum plate in the invention is a pure aluminum plate; however, since from the viewpoint of refining a completely pure aluminum cannot be easily produced, a very small amount of other elements may also be contained in the plate.

The aluminum plate used as the support is not specified in terms of the composition thereof Thus, aluminum plates which are conventionally known can be appropriately used. The thickness of the aluminum plate used in the invention is from about 0.1 to 0.6 mm, preferably from 0.15 to 0.4 mm, and more preferably from 0,2 to 0.3 mm.

If necessary, prior to the surface-roughening treatment, the aluminum plate may optionally be subjected to degreasing treatment, in order to remove rolling oil or the like on the surface, with a surfactant, an organic solvent, an aqueous alkaline solution or the like.

The surface-roughening treatment of the aluminum surface can be performed by various methods such as a mechanical surface-roughening method, a method of dissolving and roughening the surface electrochemically, and a method of dissolving the surface selectively in a chemical manner.

Mechanical surface-roughening methods which can be used may be known methods, such as a ball polishing method, a brush polishing method, a blast polishing method or a buff polishing method. An electrochemical surface-roughening method may be a method of performing surface-roughening in an electrolyte of hydrochloric acid or nitric acid, by use of an alternating current or a direct current. As disclosed in JP-A No. 54-63902, a combination of the two kinds of methods may be used.

An aluminum plate whose surface is roughened as described above is if necessary subjected to alkali-etching treatment and neutralizing treatment. Thereafter, an anodizing treatment is optionally applied in order to improve the water holding capacity and wear resistance of the surface.

The electrolyte used in the anodizing treatment of the aluminum plate is any one selected from various electrolytes which can form a porous oxide film. Among which in general use are electrolytes of sulfuric acid, phosphoric acid, oxalic acid, chromic acid, or a mixed acid thereof. The concentration of the electrolyte may be appropriately decided depending on the kind of electrolyte selected.

Treatment conditions for anodization cannot be specified as a general rule since conditions vary depending on the electrolyte used; however, the following range of conditions are generally suitable: an electrolyte concentration of 1 to 80% by mass, a solution temperature of 5 to 70° C., a current density of 5 to 60 A/dm², a voltage of 1 to 100 V, and an electrolyzing time of 10 seconds to 5 minutes. If the amount of anodic oxide film is less than 1.0 g/m², printing resistance is inadequate or non-image portions of the planographic printing plate tend to become easily damaged and the so-called “blemish stains”, resulting from ink adhering to damaged portions at the time of printing, are easily generated.

After the anodizing treatment, the surface of the aluminum is if necessary subjected to treatment for obtaining hydrophilicity. This securance of hydrophilicity treatment may be an alkali metal silicate (for example, an aqueous sodium silicate solution) method, as disclosed in U.S. Pat. Nos. 2,714,066, 3,181,461, 3,280,734, and 3,902,734. In this method, the support is subjected to an immersing treatment or an electrolyzing treatment with an aqueous sodium silicate solution.

In addition, the following methods may also be used- a method of treating the support with potassium fluorozirconate, as disclosed in JP-B No. 36-22063, or with polyvinyl phosphonic acid, as disclosed in U.S. Pat. Nos. 3,276,868, 4,153,461, and 4,689,272.

In the planographic printing plate precursor formed by providing a positive-type recording layer on a support, of the present invention, if necessary, an undercoat layer may further be formed between the support and the recording layer.

As components of the undercoat layer, various organic compounds can be used. Examples thereof include carboxymethylcellulose, dextrin, gum arabic, phosphonic acids having an amino group, such as 2-aminoethylphosphonic acid, organic phosphonic acids which may have a substituent, such as phenyl phosphonic acid, naphthylphosphonic acid, alkylphosphonic acid, glycerophosphonic acid, methylenediphosphonic acid and ethylenediphosphonic acid, organic phosphoric acids which may have a substituent, such as phenylphosphoric acid, naphthylphosphoric acid, alkylphosphoric acid and glycerophosphoric acid, organic phosphinic acids which may have a substituent, such as phenylphosphinic acid, naphthylphosphinic acid, alkylphosphinic acid and glycerophosphinic acid, amino acids such as glycine and β-alanine, and hydrochlorides of amines having a hydroxyl group, such as a hydrochloride of triethanolamine. These organic compounds may be used alone or in the form of a mixture made up of two or more thereof.

This organic undercoat layer may be formed by methods which can be described as follows: a method of applying onto the aluminum plate a solution wherein the above-mentioned organic compound is dissolved in water, or an organic solvent such as methanol, ethanol or methyl ethyl ketone, or a mixed solvent thereof and then drying the resultant aluminum plate, or a method of immersing the aluminum plate into a solution wherein the above-mentioned organic compound is dissolved in water, or an organic solvent such as methanol, ethanol or methyl ethyl ketone, or a mixed solvent thereof so as to adsorb the compound, washing the aluminum plate with water or the like, and then drying the resultant aluminum plate.

In the former method, the solution of the organic compound having a concentration of 0.05 to 10% by mass may be applied in various ways. In the latter method, the concentration of the organic compound in the solution is from 0.01 to 20%, preferably from 0.05 to 5%, the temperature for the immersion is from 20 to 90° C., preferably from 25 to 50° C., and the time taken for immersion is from 0.1 second to 20 minutes, preferably from 2 seconds to 1 minute.

The pH of the solution used in the above-mentioned methods can be adjusted into a range of 1 to 12 with a basic material such as ammonia, triethylamine or potassium hydroxide, or an acidic material such as hydrochloric acid or phosphoric acid. Moreover, a yellow dye may be added to the solution, in order to improve the tone reproducibility of the recording layer.

The amount of organic undercoat layer to be applied is appropriately 2 to 200 mg/m², and preferably 5 to 100 mg/m². When the coating amount is less than 2 mg/m², there is insufficient printing durability. This is also the same in the case when the coating amount exceeds 200 mg/m².

(Exposure/Developing)

The positive planographic printing plate precursor manufactured in the above manner is usually subjected to image exposure and developing treatment.

As the light source used for the image exposure, light sources having an emission wavelength range from the near-infrared region to the infrared region are preferable, with a solid laser and a semiconductor laser being particularly preferable.

As a developer and a replenishing solution for use with the planographic printing plate to which the invention is to be applied, a conventionally known aqueous alkali solution may be used.

Examples of the alkali agent include inorganic alkali salts such as sodium silicate, potassium silicate, trisodium phosphate, tripotassium phosphate, triammonium phosphate, disodium hydrogenphosphate, dipotassium hydrogenphosphate, diammonium hydrogenphospbate, sodium carbonate, potassium carbonate, ammonium carbonate, sodium hydrogencarbonate, potassium hydrogencarbonate, ammonium hydrogen carbonate, sodium borate, potassium borate, ammonium borate, sodium hydroxide, ammonium hydroxide, potassium hydroxide and lithium hydroxide; and organic alkali agents such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethyleneimine, ethylenediamine, and pyridine. These alkali agents may be used alone or in combinations of two or more thereof.

Among these alkali agents, silicates such as sodium silicate and potassium silicate are particularly preferable for the developer. This is because the developing capacity of the developer can be controlled by adjusting the ratio between silicon oxide (SiO₂) and alkali metal oxide (M₂O), which are components of any one of the silicates, and by adjusting the concentrations thereof. For example, alkali metal silicates as described in JP-A No. 54-62004 or JP-B No. 57-7427 can be effectively used.

In a case where an automatic developing machine is used to perform development, an aqueous solution having a higher alkali intensity than that of the developer (or, replenisher) can be added to the developer. It is known that this makes it possible to treat a great number of photosensitive plates without recourse to replacing the developer in the developing tank over a long period of time. This replenishing manner is also preferably used in the invention.

If necessary, various surfactants or organic solvents can be incorporated into the developer and the replenisher in order to promote and suppress development capacity, disperse development scum, and enhance the ink-affinity of image portions of the printing plate.

Preferable examples of the surfactant include anionic, cationic, nonionic and amphoteric surfactants. If necessary, the following may be added to the developer and the replenisher: a reducing agent (such as hydroquinone, resorcin, a sodium or potassium salt of an inorganic acid such as sulfurous acid or hydrogen sulfite acid), an organic carboxylic acid, an antifoaming agent, and a water softener.

The printing plate developed with the developer and replenisher described above is subsequently subjected to treatments with washing water, a rinse solution containing a surfactant and other components, and a desensitizing solution containing gum arabic and a starch derivative. For after treatment following use of the photosensitive composition of the invention as a planographic printing plate precursor, various combinations of these treatments may be employed.

In recent years, automatic developing machines for printing plate precursors have been widely used in order to rationalize and standardize plate-making processes in the plate-making and printing industries. These automatic developing machines are generally made up of a developing section and a post-processing section, and include a device for carrying printing plate precursors, various treating solution tanks, and spray devices. These machines are machines for spraying respective treating solutions, which are pumped up, onto an exposed printing plate through spray nozzles, for development, while the printing plate is transported horizontally.

Recently, a method has also attracted attention in which a printing plate precursor is immersed in treating solution tanks filled with treating solutions and conveyed by means of in-liquid guide rolls. Such automatic processing can be performed while replenishers are being replenished into the respective treating solutions in accordance with the amounts to be treated, operating times, and other factors.

A so-called use-and-dispose processing manner can also be used, in which treatments are conducted with treating solutions which in practice have yet been used.

In cases where unnecessary image portions (for example, a film edge mark of an original picture film) are present on a planographic printing plate obtained by exposing imagewise to light a planographic printing plate precursor to which the invention is applied, developing the exposed precursor, and subjecting the developed precursor to water-washing and/or rinsing and/or desensitizing treatment(s), unnecessary image portions can be erased.

The erasing is preferably performed by applying an erasing solution to unnecessary image portions, leaving the printing plate as it is for a given time, and washing the plate with water, as described in, for example, JP-B No. 2-13293. This erasing may also be performed by a method of radiating active rays introduced through an optical fiber onto the unnecessary image portions, and then developing the plate, as described in JP-A No. 59-174842.

The developed planographic printing plate thus obtained may be further coated with a desensitizing gum if desired before it is sent to the printing process; or the plate is additionally subjected to a baking treatment, if desired, for the purpose of obtaining planographic printing plates higher in printing durability.

It is preferable to treat the plate precursor with an affinitizing solution described in JP-B Nos. 61-2518 and 55-28062 and JP-A Nos. 62-31859 and 61-159655 before the baking treatment. The methods include application of the affinitizing solution onto the planographic printing plate with a sponge or cotton moistened therewith, application by immersing the printing plate into a bath filled with the affinitizing solution, and application by an automatic coater Additionally, adjustment of the coating amount to uniformity by using a squeezee or a squeezee roller after application of the affinitizing solution leads to further preferable results.

The suitable amount of the affinitizing solution coated is generally 0.03 to 0.8 g/m² (as dry weight). The planographic printing plate with the affinitizing solution applied thereon may then be dried as needed. Thereafter, the planographic printing plate is heated at high temperature in a baking processor (e.g. Baking Processor BP-1300, sold by Fuji Photo Film) or the like. The temperature and the period of the heating vary according to the kind of the components constituting the image layer, but are preferably in the range of 180 to 300° C. for 1 to 20 minutes.

The planographic printing plate after the baking treatment may be then subjected if needed to treatments commonly practiced in the art such as water washing and gumming, but if an affinitizing solution containing a water-soluble polymer compound or the like is used, so-called desensitizing treatments such as gumming and the like may be eliminated.

The planographic printing plates obtained after these treatments are then supplied to an offset printing machine or the like, wherein they are used for printing numerous papers.

When the photosensitive composition of the present invention is used as the recording layer of a planographic printing plate precursor, an image of high quality which has excellent development discrimination and is free of stains in non-image portions can be formed.

### EXAMPLES

The invention will be explained hereinbelow in detail by way of examples, but the invention is not limited thereto. Here, the photosensitive composition of the invention will be evaluated by way of the evaluation of a planographic printing plate precursor using the photosensitive composition of the invention in a recording layer.

(Preparation of Support)

Supporting plates were prepared in the following steps, using a JIS-A-1050 aluminium plate having a thickness of 0.3 mm.

(a) Mechanical Surface-Roughening Treatment

While a suspension of an abrasive agent (silica sand) having a specific gravity of 1.12 in water was supplied as an abrading slurry onto a surface of any one of the aluminum plates, the surface was mechanically roughened with rotating roller-form nylon brushes. The average grain size of the abrasive agent was 8 μm and the maximum grain size thereof was 50 μm. The material of the nylon brushes was 6-10-nylon, the length of bristles thereof was 50 mm, and the diameter of the bristles was 0.3 mm. The nylon brushes were each obtained by making holes in a stainless steel cylinder having a diameter of 300 mm and then planting bristles densely into the holes. The number of the used rotating brushes was three. The distance between the two supporting rollers (diameter: 200 mm) under each of the brushes was 300 mm. Each of the brush rollers was pushed against the aluminum plate until the load of a driving motor for rotating the brush became 7 kW larger than the load before the brush roller was pushed against the aluminum plate. The rotating direction of the brush was the same as the moving direction of the aluminum plate. The rotation speed of the brush was 200 rpm.

(b) Alkali Etching Treatment

A 70° C. aqueous solution of NaOH (NaOH concentration: 26% by mass, and aluminum ion concentration: 6.5% by mass) was sprayed onto the aluminum plate obtained in the above-mentioned manner to etch the aluminum plate, thereby dissolving the aluminum plate by 6 g/m². Thereafter, the aluminum plate was washed with water.

(c) Desmutting Treatment

The aluminum plate was subjected to desmutting treatment with a 30° C. aqueous solution having a nitric acid concentration of 1% by mass (and containing 0.5% by mass of aluminum ions), which was sprayed, and then washed with water. The aqueous nitric acid solution used in the desmutting treatment was waste liquid derived from the step of conducting electrochemical surface-roughening treatment using alternating current in an aqueous nitric acid solution.

(d) Electrochemical Surface-Roughening Treatment

Alternating current having a frequency of 60 Hz was used to conduct electrochemical surface-roughening treatment continuously. The electrolyte used at this time was a 10.5 g/L solution of nitric acid in water (containing 5 g/L of aluminum ions), and the temperature thereof was 50° C. The wave of the used alternating current was a trapezoidal wave wherein the time TP until the current value was raised from zero to a peak was 0.8 msec, and the duty ratio of the current was 1:1. This trapezoidal wave alternating current was used, and a carbon electrode was set as a counter electrode to conduct the electrochemical surface-roughening treatment. Ferrite was used as an auxiliary anode. The used electrolyte bath was a radial cell type bath.

The density of the current was 30 A/dm² when the current was at the peak. The total amount of consumed electricity when the aluminum plate functioned as an anode was 220 C/dm². Five percent of the current sent from a power source was allowed to flow into the auxiliary anode.

Thereafter, the aluminum plate was washed with water.

(e) Alkali Etching Treatment

An aqueous solution having a caustic soda of 26% by mass and an aluminum ion concentration of 6.5% by mass was sprayed onto the aluminum plate to etch the plate at 32° C. so as to dissolve the aluminum plate by 0.20 g/m², thereby removing smut components made mainly of aluminum hydroxide and generated when the alternating current was used to conduct the electrochemical surface-roughening treatment in the previous step, and further dissolving edges of formed pits so as to be made smooth. Thereafter, the aluminum plate was washed with water.

(f) Desmut Treatment

The aluminum plate was subjected to desmutting treatment with a 30° C. aqueous solution having a nitric acid concentration of 15% by mass (and containing 4.5% by mass of aluminum ions), which was sprayed, and then washed with water. The aqueous nitric acid solution used in the desmutting treatment was waste liquid derived from the step of conducting the electrochemical surface-roughening treatment using the alternating current in the aqueous nitric acid solution.

(g) Electrochemical Surface-Roughening Treatment

Alternating current having a frequency of 60 Hz was used to conduct electrochemical surface-roughening treatment continuously. The electrolyte used at this time was a 7.5 g/L solution of hydrochloric acid in water (containing 5 g/L of aluminum ions), and the temperature thereof was 35° C. The wave of the alternating current was a rectangular wave. A carbon electrode was set as a counter electrode to conduct the electrochemical surface-roughening treatment. Ferrite was used as an auxiliary anode. The used electrolyte bath was a radial cell type bath.

The density of the current was 25 A/dm² when the current was at the peak. The total amount of consumed electricity when the aluminum plate functioned as an anode was 50 C/dm².

Thereafter, the aluminum plate was washed with water.

(h) Alkali Etching Treatment

An aqueous solution having a caustic soda of 26% by mass and an aluminum ion concentration of 6.5% by mass was sprayed onto the aluminum plate to etch the plate at 32° C. so as to dissolve the aluminum plate by 0.10 g/m², thereby removing smut components made mainly of aluminum hydroxide and generated when the alternating current was used to conduct the electrochemical surface-roughening treatment in the previous step, and further dissolving edges of formed pits so as to be made smooth. Thereafter, the aluminum plate was washed with water.

(i) Desmutting Treatment

The aluminum plate was subjected to desmutting treatment with a 60° C. aqueous solution having a sulfuric acid concentration of 25% by mass (and containing 0.5% by mass of aluminum ions), which was sprayed, and then washed with water.

(j) Anodizing Treatment

As electrolytes, sulfuric acid was used. The electrolytes were each an electrolyte having a sulfuric acid concentration of 170 g/L (and containing 0.5% by mass of aluminum ions), and the temperature thereof was 43° C. Thereafter, the support was washed with water.

The current densities were each about 30 A/dm². The final amount of the oxidation film was 2.7 g/m².

<Support A>

The above steps (a) to (j) were successively performed and the etching amount in step (e) was set to 3.4 g/m², so as to form a support A.

<Support B>

The abovementioned steps other than steps (g), (h) and (i) were successively performed to form a support B.

<Support C>

The above-mentioned steps other than steps (a), (g), (h) and (i) were successively performed to form a support C.

<Support D>

The above-mentioned steps other than the steps (a), (g), (h) and (i) were successively performed, and the total amount of consumed electricity in step (g) was set to 450 C/dm², to form a support D.

The supports A, B, C and D obtained in the above-mentioned manner were subjected to the following treatment to make the support surface hydrophilic and apply undercoat to the support.

(k) Treatment with Alkali Metal Silicate

Each of the aluminum supports A to D obtained in the above-mentioned manner was immersed into a treatment tank containing a 30° C. aqueous solution of #3 sodium silicate (concentration of sodium silicate: 1% by mass) for 10 seconds to subject the support to treatment with the alkali metal silicate (silicate treatment). Thereafter, the support was washed with water. The amount of the silicate adhering at this time was 3.5 mg/m².

(Undercoat Treatment)

An undercoat solution having the following composition was applied onto each of the aluminum supports treated with the alkali metal silicate, which supports were obtained in the above-mentioned manner, and the resultant was dried at 80° C. for 15 seconds. The applied amount of solid contents after the drying was 18 mg/M².

| | | |
|---|---|---|
| <Undercoat solution composition> | | |
| Polymer compound having a structure illustrated below | 0.3 | g |
| Methanol | 100 | g |
| Water | 1.0 | g |
| 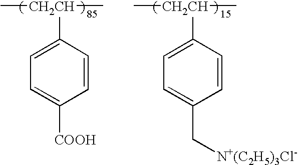 | | |
| Weight-average molecular weight: 26,000 | | |

### Examples 1 to 7, Comparative Examples 1 and 2

A first layer (lower layer) coating solution having the below-mentioned composition was applied with a wire bar onto an obtained support A and dried at 150° C. for 60 seconds in a drying oven such that the coating amount was 0.95 g/m².

A second layer (upper layer) coating solution having the below-mentioned composition was applied with a wire bar onto the obtained support having the lower layer. After the coating solution was applied, it was dried at 130° C. for 90 seconds in a drying oven such that the total coating amount was 1.25 g/m² to manufacture the positive planographic printing plate precursors of Examples 1 to 7 and Comparative Examples 1 and 2.

| | |
|---|---|
| <First layer (lower layer) coating solution> | |
| Copolymer 1 (copolymer synthesized in the following manner) | 1.833 g |
| Cyanine dye A (the following structure) | 0.098 g |
| 2-Mercapto-5-methylthio-1,3,4-thiadiazole | 0.030 g |
| Cis-Δ⁴-tetrahydrophthalic acid anhydride | 0.100 g |
| 4,4′-sulfonyldiphenol | 0.090 g |
| p-Toluenesulfonic acid | 0.008 g |
| Ethyl violet whose counter anion was changed to | 0.100 g |
| 6-hydroxynaphthalenesulfonic acid | |
| 3-Methoxy-4-diazodiphenylamine hexafluorophosphate | 0.030 g |
| Fluorine-based surfactant (trade name: Megaface F-780, | 0.035 g |
| manufactured by Dainippon Ink and Chemicals Incorporated) | |
| Methyl ethyl ketone | 26.6 g |
| 1-Methoxy-2-propanol | 13.6 g |
| γ-butyrolactone | 13.8 g |

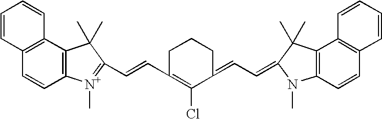

Cyanine dye A

<Synthesis of Copolymer 1>

A 500 ml three-neck flask equipped with a stirrer a cooling tube and a dropping funnel was charged with 31.0 g (0.36 mol) of methacrylic acid, 39.1 g (0.36 mol) of ethyl chloroformate, and 200 ml of acetonitrile and the mixture was stirred while cooling using an ice water bath. 36.4 g (0.36 mol) of triethylamine was added dropwise to the mixture over one hour by a dropping funnel. After the dropwise addition was finished, the ice water bath was removed and the mixture was stirred at ambient temperature for 30 minutes.

51.7 g (0.30 mol) of p-aminobenzenesulfonamide was added to this reaction mixture, which was then stirred for one hour while heating it at 70° C. in an oil bath. After the reaction was finished, this mixture was poured into 1 liter of water while stirring the water, and the resulting mixture was stirred for 30 minutes. This mixture was subjected to filtration to extract the precipitates, which were made into a slurry by adding 500 ml of water. Then, this slurry was subjected to filtration and the obtained solid was dried to obtain a white solid of N-(p-aminosulfonylphenyl)methacrylamide (yield: 46.9 g).

Next, a 20 ml three-neck flask equipped with a stirrer, a cooling tube and a dropping funnel was charged with 4.61 g (0.0192 mol) of N-(p-aminosulfonylphenyl)methacrylamide, 2.58 g (0.0258 mol) of ethylmethacrylate, 0.80 g (0.01 5 mol) of acrylonitrile and 20 g of N,N′-dimethylacetamide, and the mixture was stirred while heating it at 65° C. using a hot water bath. 0.15 g of 2,2′-azobis(2,4-dimethylvaleronitrile) (trade name: “V-65”, manufactured by Wako Pure Chemical Industries, Ltd.) was added as a polymerization initiator to the mixture. The resulting mixture was stirred in a nitrogen stream while keeping the mixture at 65° C. for 2 hours. Further, a mixture of 4.61 g of N-(p-aminosulfonylphenyl)methacrylamide, 2.58 g of methylmethacrylate, 0.80 g of acrylonitrile, 20 g of N,N-dimethylacetamide, and 0.15 g of “V-65” was added dropwise to the reaction mixture using a dropping funnel over 2 hours. After the dropwise addition was finished, the resulting mixture was further stirred at 65° C. for 2 hours. After the reaction was finished, 40 g of methanol was added to the mixture, which was then cooled, and the resulting mixture was poured into 2 liters of water while stirring the water. After the mixture was stirred for 30 minutes, the precipitates were extracted by filtration, and dried to obtain 15 g of a white solid. The weight average molecular weight (based on the polystyrene standard) of this specific copolymer 1 was measured by gel permeation chromatography, and found to be 54,000.

<Second layer (upper layer) coating solution>

| | | |
|---|---|---|
| Copolymer of ethylmethacrylate and | 0.050 | g |
| 2-methacryloyloxyethylsuccinic acid | | |
| (molar ratio 75:25, weight average | | |
| molecular weight: 70,000) | | |
| Phenol cresol/formaldehyde novolac | 0.500 | g |
| (phenol:m-cresol:p-cresol = 30:50:20, | | |
| weight average molecular weight: 8800) | | |
| Acid generator | 0.08 | g |
| (specific acid generator described | | |
| in Table 1 or comparative compound) | | |
| Cyanine dye A (the above structure) | 0.015 | g |
| Ethyl violet whose counter anion was changed to | 0.012 | g |
| 6-hydroxynaphthalenesulfonic acid | | |
| Fluorine-based surfactant (trade name: | 0.022 | g |
| Megaface F-780, manufactured by | | |
| Dainippon Ink and Chemicals Incorporated) | | |
| Methyl ethyl ketone | 13.1 | g |
| 1-Methoxy-2-propanol | 6.79 | g |

The number of each specific acid generator described in Table I designates the compound No. of the above exemplified compounds. Also, the structure of the acid generator (Compound A to Compound E) to be used in each Comparative Example shown below is as follows. 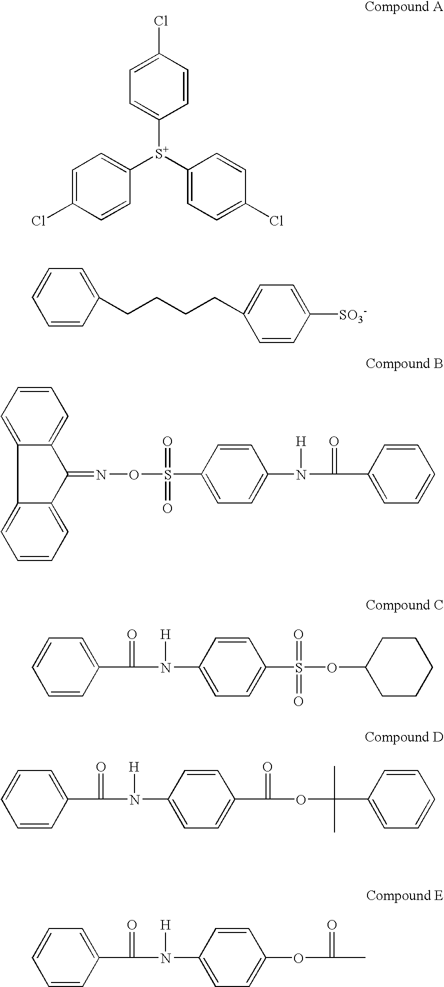
[Evaluation of a Planographic Printing Plate Precursor]

The evaluation of the planographic printing plate precursor was made with regard to each item of development latitude and resistance to staining. The details of evaluation methods are as follows.

1. Development Latitude

The planographic printing plate precursor was stored under the conditions of a temperature of 25° C. and a relative humidity of 50% for 5 days, and then a test pattern was drawn imagewise on the planographic printing plate precursor by a Trendsetter 3244 VX manufactured by Creo under the following conditions: beam intensity of 10.0 W and drum rotation at 125 rpm.

Then, in the alkali developers having the following compositions A and B respectively, the mass ratio of water in each composition was changed to change the dilution, thereby preparing alkali developers having different conductivities, which were each placed in a PS Processor 900H manufactured by Fuji Photo Film Co., Ltd., at a temperature of 30° C. for a developing time of 25 seconds to develop the planographic printing plate precursor. At this time, the conductivity of each developer was measured, when the image portion was not eluted and was free from any staining or coloration caused by the residual film of the photosensitive layer resulting from inferior development so that the planographic printing plate precursor was well developed, to evaluate the difference in conductivity between a developer having the highest conductivity and a developer having the lowest conductivity as a development latitude.

<Alkali developer A composition>

| | | |
|---|---|---|
| SiO₂—K₂O (K₂O/SiO₂ = 1/1 (molar ratio)) | 4.0 | wt % |
| Citric acid | 0.5 | wt % |
| Polyethylene glycol lauryl ether | 0.5 | wt % |
| (weight average molecular weight: 1,000) | | |
| Water | 95.0 | wt % |

<Alkali developer B composition>

| | | |
|---|---|---|
| D-sorbitol | 2.5 | wt % |
| Sodium hydroxide | 0.85 | wt % |
| Polyethylene glycol lauryl ether | 0.5 | wt % |
| (weight average molecular weight: 1,000) | | |
| Water | 96.15 | wt % |

2. Evaluation of the Chemical Resistance of the Image Portion

Among the planographic printing plates obtained in the above evaluation test and those obtained using the developers enabling good developing without any staining or coloration caused by the residual film of the photosensitive layer resulting from inferior development, a planographic printing plate obtained by developing using a developer having a developing activity that was midpoint between that of the developer having the highest conductivity and that of the developer having the lowest conductivity was used to carry out printing. At this time, a process was added of wiping the surface of the plate with a cleaner (trade name: MULTICLEANER, manufactured by Fuji Photo Film Co., Ltd.) every time 5000 copies were printed in order to evaluate the chemical resistance of the plate. The larger the number of copies were, the better the chemical resistance was evaluated to be.

3. Evaluation of the Resistance to Contamination in a Non-Image Portion

Among the planographic printing plates obtained in the above evaluation test and those obtained using the developers enabling good developing without any staining or coloration caused by the residual film of the photosensitive layer resulting from inferior development, a planographic printing plate obtained by developing using a developer having a developing activity that was midpoint between that of the developer having the highest conductivity and that of the developer having the lowest conductivity was used to carry out printing with a Mitsubishi Daiya-model F2 Printer using DIC-GEOS (s) rouge ink. The staining of a blanket after 10000 sheets were printed was evaluated visually.

The evaluation standard was as follows: A: No staining was observed, B: Almost no staining was observed and C; Significant staining was observed.

<Evaluation of the Planographic Printing Plate Precursors of Examples 1 to 7 and Comparative Examples 1 and 2>

The development latitude and chemical resistance of the planographic printing plate precursors of Examples 1 to 7 and Comparative Examples 1 and 2 were evaluated using the above methods. As the developer, developer B was used. The results are shown in Table 1.

TABLE 1

| | | | Chemical | |
|---|---|---|---|---|
| | Acid | Development | resistance (10⁴ | Resistance to |
| | generator | latitude | sheets) | staining |
| Example 1 | A-1 | 8 | 20 | A |
| Example 2 | S-5 | 8 | 21 | A |
| Example 3 | S-17 | 8 | 20 | A |
| Example 4 | S-21 | 8 | 21 | A |
| Example 5 | S-28 | 8 | 21 | A |
| Example 6 | S-42 | 8 | 19 | A |
| Example 7 | T-2 | 7.5 | 23 | A |
| Comparative | Compound | 6.5 | 12 | C |
| Example 1 | A | | | |
| Comparative | Compound | 6.0 | 13 | C |
| Example 2 | B | | | |

As shown in Table 1, it was found that each planographic printing plate precursor of Examples 1 to 7, each using the photosensitive composition of the invention as the recording layer, exhibited improved development latitude, chemical resistance, and resistance to staining. On the other hand, Comparative Examples 1 and 2, each using compounds out of the scope of the invention as the acid generator, exhibited inferior development latitude and also large deterioration of both chemical resistance and resistance to staining of a non-image portion compared to the Examples.

### Examples 8 to 14, Comparative Examples 3 and 4

A first layer (lower layer) coating solution having the following composition was applied with a wire bar onto an obtained support C and dried at 120° C. for 90 seconds in a drying oven such that the coating amount was 0.60 g/m².

A second layer (upper layer) coating solution having the following composition was applied with a wire bar onto the obtained support having the lower layer. After the coating solution was applied, it was dried at 120° C. for 90 seconds in a drying oven such that the total coating amount was 1.35 g/m² to manufacture the positive planographic printing plate precursors of Examples 8 to 14 and Comparative Examples 3 and 4.

<First layer (lower layer) coating solution>

| | | |
|---|---|---|
| Copolymer 1 (the above structure) | 2.200 | g |
| Cyanine dye A (the above structure) | 0.098 | g |
| 2-Mercapto-5-methylthio-1,3,4- | 0.030 | g |
| thiadiazole | | |
| Cis-Δ⁴-tetrahydrophthalic acid | 0.100 | g |
| anhydride | | |
| 4,4′-sulfonyldiphenol | 0.090 | g |
| p-Toluenesulfonic acid | 0.008 | g |
| Ethyl violet whose counter anion was changed | 0.100 | g |
| to 6-hydroxynaphthalenesulfonic acid | | |
| 3-Methoxy-4-diazodiphenylamine | 0.030 | g |
| hexafluorophosphate | | |
| Fluorine-based surfactant (trade name: | 0.035 | g |
| Megaface F-780, manufactured by Dainippon | | |
| Ink and Chemicals Incorporated) | | |
| Methyl ethyl ketone | 26.6 | g |
| 1-Methoxy-2-propanol | 13.6 | g |
| Dimethyl sulfoxide | 13.8 | g |

<Second layer (upper layer) coating solution>

| | | |
|---|---|---|
| Copolymer of ethylmethacrylate and | 0.020 | g |
| 2-methacryloyloxyethylsuccinic acid | | |
| (molar ratio 70:30, weight average | | |
| molecular weight: 88,000) | | |
| Phenol cresol/formaldehyde novolac | 0.260 | g |
| (phenol:m-cresol:p-cresol = 10:70:20, | | |
| weight average molecular weight: 7700) | | |
| Acid generator (specific acid generator | 0.01 | g |
| described in Table 2 or comparative compound) | | |
| Cyanine dye A (the above structure) | 0.015 | g |
| Fluorine-based surfactant (trade name: | 0.022 | g |
| Megaface F-780, manufactured by Dainippon | | |
| Ink and Chemicals Incorporated) | | |
| Methyl ethyl ketone | 13.1 | g |
| 1-Methoxy-2-propanol | 6.79 | g |

### Evaluation of Examples 8 to 14 and Comparative Examples 3 and 4

The planographic printing plate precursors of Examples 8 to 14 and Comparative Examples 3 and 4 were evaluated in the same manner as in Example 1. As the developer, developer B was used. The results are shown in Table 2. The number of each specific acid generator described in Table 2 designates the compound No. of the above exemplified compounds or the compound symbol of the comparative acid generators.

TABLE 2

| | | | Chemical | |
|---|---|---|---|---|
| | Acid | Development | resistance (10⁴ | Resistance to |
| | generator | latitude | sheets) | Staining |
| Example 8 | B-1 | 8 | 20 | A |
| Example 9 | C-5 | 8 | 21 | A |
| Example 10 | G-6 | 8 | 21 | A |
| Example 11 | S-12 | 8 | 20 | A |
| Example 12 | S-18 | 8 | 19 | A |
| Example 13 | S-27 | 8 | 19 | A |
| Example 14 | T-8 | 7 | 24 | A |
| Comparative | Compound | 6.0 | 12 | C |
| Example 3 | A | | | |
| Comparative | Compound | 5.5 | 12 | C |
| Example 4 | C | | | |

As shown in Table 2, it is confirmed that each planographic printing plate precursor of the Examples exhibited improved development latitude, chemical resistance, and resistance to staining compared to the Comparative Examples, showing that the same results as those obtained in Examples 1 to 7 are obtained. It is understood from these results that even if the constituents of the photosensitive layer are different, the planographic printing plate precursors using the photosensitive composition of the invention for the recording layer produce the same excellent effects.

### Examples 15 to 21, Comparative Examples 5 and 6

A first layer (lower layer) coating solution having the following composition was applied with a wire bar onto an obtained support D and dried at 150° C. for 60 seconds in a drying oven such that the coating amount was 0.81 g/m².

A second layer (upper layer) coating solution having the following composition was applied with a wire bar onto the obtained support having the lower layer. After the coating solution was applied, it was dried at 120° C. for 90 seconds in a drying oven such that the total coating amount was 1.1 g/m² to manufacture positive the planographic printing plate precursors of Examples 15 to 21 and Comparative Examples 5 and 6.

<First layer (lower layer) coating solution>

| | | |
|---|---|---|
| Copolymer 1 mentioned above | 2.133 | g |
| Cyanine dye A (the above structure) | 0.098 | g |
| Cis-Δ⁴-tetrahydrophthalic | 0.110 | g |
| acid anhydride | | |
| 4,4′-sulfonyldiphenol | 0.090 | g |
| p-Toluenesulfonic acid | 0.008 | g |
| Ethyl violet whose counter anion | 0.100 | g |
| was changed to 6- | | |
| hydroxynaphthalenesulfonic acid | | |
| 3-Methoxy-4-diazodiphenylamine | 0.030 | g |
| hexafluorophosphate | | |
| Fluorine-based surfactant (trade name: | 0.035 | g |
| Megaface F-780, manufactured by Dainippon | | |
| Ink and Chemicals Incorporated) | | |
| Methyl ethyl ketone | 26.6 | g |
| 1-Methoxy-2-propanol | 13.6 | g |
| γ-butyrolactone | 13.8 | g |

<Second layer (upper layer) coating solution>

| | | |
|---|---|---|
| Copolymer of ethylmethacrylate and | 0.0380 | g |
| 2-methacryloyloxyethylsuccinic acid | | |
| (molar ratio 65:35, weight average | | |
| molecular weight: 78,000) | | |
| Cresol/formaldehyde novolak | 0.400 | g |
| (m-cresol:p-cresol = 80:20, | | |
| weight average molecular weight; 4100) | | |
| Acid generator (specific acid generator | 0.0110 | g |
| described in Table 3 or comparative compound) | | |
| Cyanine dye A (the above structure) | 0.015 | g |
| Fluorine-based surfactant (trade name: | 0.022 | g |
| Megaface F-780, manufactured by Dainippon | | |
| Ink and Chemicals Incorporated) | | |
| Methyl ethyl ketone | 13.1 | g |
| 1-Methoxy-2-propanol | 6.79 | g |

### Evaluation of Examples 15 to 21 and Comparative Examples 5 and 6

The obtained planographic printing plate precursors were evaluated in the same manner as above. As the developer, developer A was used. The results are shown in Table 3. The number of each specific acid generator described in Table 3 designates the compound No. of the above exemplified compounds or the compound symbol of the comparative compounds.

TABLE 3

| | | | Chemical | |
|---|---|---|---|---|
| | Acid | Development | resistance (10⁴ | Resistance to |
| | generator | latitude | sheets) | staining |
| Example 15 | D-6 | 8 | 21 | A |
| Example 16 | E-1 | 8 | 21 | A |
| Example 17 | S-15 | 8 | 20 | A |
| Example 18 | S-22 | 8 | 20 | A |
| Example 19 | S-28 | 8 | 21 | A |
| Example 20 | S-44 | 8 | 19 | A |
| Example 21 | T-9 | 7.5 | 24 | A |
| Comparative | Compound | 6.0 | 11 | C |
| Example 5 | A | | | |
| Comparative | Compound | 5.5 | 13 | C |
| Example 6 | D | | | |

As shown in Table 3, it is understood that each planographic printing plate precursor of Examples 15 to 21 exhibited improved development latitude, chemical resistance, and resistance to staining.

### Examples 22 to 28, Comparative Examples 7 and 8

An image forming coating solution having the following composition was applied onto an obtained support D and dried at 120° C. for 90 seconds to form an image forming layer, thereby obtaining each planographic printing plate precursor of Examples 22 to 28 and Comparative Examples 7 and 8. The dried coating amount was 1.60 g/m².

<Image forming layer coating solution>

| | | |
|---|---|---|
| Phenol/cresol/formaldehyde novolac | 1.0 | g |
| (phenol:m-cresol:p-cresol = 30:50:20, | | |
| weight average molecular weight: 6500) | | |
| Acid generator (the specific acid generator | 0.03 | g |
| described in Table 2 or comparative compound) | | |
| Cyanine dye A (the above structure) | 0.05 | g |
| Dye obtained by using a 1-naphthalenesulfonic | 0.01 | g |
| acid anion as the counter anion of Victoria | | |
| Pure Blue | | |
| Fluorine-based surfactant (trade name: | 0.05 | g |
| Megaface F-780, manufactured by | | |
| Dainippon Ink and Chemicals Incorporated) | | |
| Methyl ethyl ketone | 9.0 | g |
| 1-Methoxy-2-propanol | 9.0 | g |

### Evaluation of Examples 22 to 28 and Comparative Examples 7 and 8

The obtained planographic printing plate precursors of Examples 22 to 28 and Comparative Examples 7 and 8 were evaluated in the same manner as in Example 1. As the developer, developer A was used. The results are shown in Table 4.

The number of each specific acid generator described in Table 4 designates the compound No. of the above exemplified compounds or the compound symbol of the comparative compounds.

TABLE 4

| | | | Chemical | |
|---|---|---|---|---|
| | Acid | Development | resistance (10⁴ | Resistance to |
| | generator | latitude | sheets) | staining |
| Example 22 | F-3 | 8 | 19 | A |
| Example 23 | H-3 | 8 | 21 | A |
| Example 24 | S-16 | 8 | 19 | A |
| Example 25 | S-25 | 8 | 21 | A |
| Example 26 | S-31 | 8 | 20 | A |
| Example 27 | S-32 | 8 | 19 | A |
| Example 28 | T-10 | 7.5 | 22 | A |
| Comparative | Compound | 5.5 | 13 | C |
| Example 7 | A | | | |
| Comparative | Compound | 5.5 | 13 | C |
| Example 8 | E | | | |

As shown in Table 4, it is understood that each planographic printing plate precursor of Examples 22 to 28 exhibited improved development latitude, chemical resistance, and resistance to staining.

Also, when comparing Examples I to 7 with Examples 22 to 28, it was confirmed that the planographic printing plate precursor using the photosensitive composition of the invention for the recording layer produced the excellent effect of the invention even in the case when the recording layer was a monolayer similarly to the case when the recording layer was a multilayer.

What is claimed is:

1. A positive photosensitive composition comprising:
(A) a compound represented by the following formula (1) which is decomposed by exposure to light to generate an acid;
(B) a high-molecular compound having a phenolic hydroxyl group; and
(C) an infrared-light absorber:
Z-Y—[R]ₚ General Formula (1)
p: 1˜4
wherein R represents an alkyl, cycloalkyl, aralkyl or aryl group having an acid group, Y represents a bivalent to tetravalent connecting group having at least one partial structure selected from the following group of partial structures or a terminal group selected from one of the partial structures and a terminal hydrogen atom and Z does not exist when Y is a terminal group, but represents a monovalent to tetravalent connecting group or terminal group when Y is a connecting group.

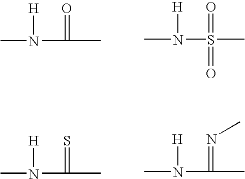

2. The positive photosensitive composition of claim 1, wherein the pKa of the acid group in the alkyl, cycloalkyl, aralkyl or aryl group of R in the formula (1) is 15 or less.

3. The positive photosensitive composition of claim 2, wherein the pKa of the acid groupin the alkyl, cycloalkyl, aralkyl or aryl group of R in the formula (1) is 13 or less.

4. The positive photosensitive composition of claim 3, wherein the pKa of the acid group in the alkyl, cycloalkyl, aralkyl or aryl group of R in the formula (1) is 2 to 11.

5. The positive photosensitive composition of claim 1, wherein the acid group in the alkyl cycloalkyl, aralkyl or aryl group of R in the formula (1) is selected from the group consisting of a phenolic hydroxyl group, a sulfonamide group, a substituted sulfonamide-based acid group, a carboxy group, a sulfonic acid group and a phosphonic acid group.

6. The positive photosensitive composition of claim 1, wherein the acid group in the alkyl, cycloalkyl, aralkyl or aryl group of R in the formula (1) is a functional group that can be decomposed to form an acid group.

7. The positive photosensitive composition of claim 1, wherein R in the formula (1) is an unsubstituted aryl group having an acid group.

8. An image recording material comprising;
a support; and
a recording layer which is disposed on the support and comprising a specific photosensitive composition, wherein:
the photosensitive composition of the recording layer contains (A) a compound represented by the following formula (1) which is decomposed by exposure to light to generate an acid, (B) a high-molecular compound having a phenolic hydroxyl group, and (C) an infrared-light absorber;
Z-Y—[R]ₚ General Formula (1)
p: 1˜4
wherein R represents an alkyl, cycloalkyl, aralkyl or aryl group having an acid group, Y represents a bivalent to tetravalent connecting group having at least one partial structure selected from the following group of partial structures or a terminal group selected from one of the partial structures and a terminal hydrogen atom, and Z does not exist when Y is a terminal group, but represents a monovalent to tetravalent connecting group or terminal group when Y is a connecting group;

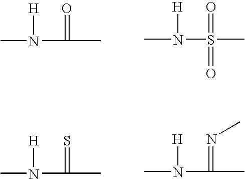

9. The image recording material of claim 8, wherein the pKa of the acid group in the alkyl cycloalkyl, aralkyl or aryl group of R in the formula (1) is 15 or less.

10. The image recording material of claim 9, wherein the pKa of the acid group in the alkyl, cycloalkyl, aralkyl or aryl group of R in the formula (1) is 13 or less.

11. The image recording material of claim 10, wherein the pKa of the acid group in the alkyl, cycloalkyl, aralkyl or aryl group of R in the formula (1) is 2 to 11.

12. The image recording material of claim 8, wherein the acid group in the alkyl, cycloalkyl, aralkyl or aryl group of R in the formula (1) is selected from the group consisting of a phenolic hydroxyl group, a sulfonamide group, a substituted sulfonamide-based acid group, a carboxy group, a sulfonic acid group and a phosphonic acid group.

13. The image recording material of claim 8, wherein the acid group in the alkyl, cycloalkyl, aralkyl or aryl group of R in the formula (1) is a functional group that can be decomposed to form an acid group.

14. The image recording material of claim 8, wherein R in the formula (1) is an unsubstituted aryl group having an acid group.

15. A positive photosensitive composition comprising:
(A-1) a sulfonium salt or an iodonium salt having a compound represented by the following formula (1-1) as a counter anion,
(B) a high-molecular compound having a phenolic hydroxyl group; and
(C) an infrared-light absorber:
Z-Y—[R]ₚ General Formula (1-1)
p: 1˜4
wherein R represents an alkyl, cycloalkyl, aralkyl or aryl group having an anion group, Y represents a bivalent to tetravalent connecting group having at least one partial structure selected from the following group of partial structures or a terminal group selected from one of the partial structures and a terminal hydrogen atom and Z does not exist when Y is a terminal group, but represents a monovalent to tetravalent connecting group or terminal group when Y is a connecting group.

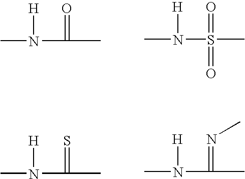

16. The positive photosensitive composition of claim 15, wherein the (A-1) sulfonium salt is a triaryl sulfonium salt or iodonium salt is a diaryl iodonium salt.

17. The positive photosensitive composition of claim 15, wherein the (A-1) sulfonium salt is represented by the following general formula (1-2): 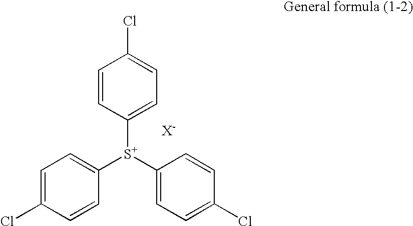
wherein x represents the compound represented by the formula (1-1).

18. The positive photosensitive composition of claim 15, wherein the anion group in the general formula (1-1) is a group dissociated from a group selected from an active imide group, a sulfonic acid group and a phosphoric acid group.

19. The positive photosensitive composition of claim 15, wherein the (B) high-molecular compound is a novolac-based phenol resin that is mixture of phenol and cresol containing 30 to 85% by mole of a phenol as a structural unit.

20. The positive photosensitive composition of claim 15, wherein the (B) high-molecular compound is a novolac-based phenol resin that is mixture of phenol and cresol containing 30 to 85% by mole of phenol and 20 to 50% by mole of m-cresol as a structural unit.

21. The positive photosensitive composition of claim 15, further comprising an alkali-soluble resin selected from a sulfone imide-based polymer, a polymer containing a carboxyl group, and a polymer containing a sulfonamide group.

22. A positive photosensitive composition comprising:
(A-2) a compound which is selected from a sulfonate ester, a disulfone, a sulfone imide, a diazo disulfone, a ketosulfone, and a carboxylic acid ester, and decomposed by exposure to light to generate a sulfonic acid anion represented by following formula (1-3);
(B) a high-molecular compound having a phenolic hydroxyl group; and
(C) an infrared-light absorber:
Z-Y—[R]ₚ General Formula (1-3)
p: 1˜4
wherein R represents an alkyl, cycloalkyl, aralkyl or aryl group having an sulfonic acid group, Y represents a bivalent to tetravalent connecting group having at least one partial structure selected from the following group of partial structures or a terminal group selected from one of the partial structures and a terminal hydrogen atom and Z does not exist when Y is a terminal group, but represents a monovalent to tetravalent connecting group or terminal group when Y is a connecting group.

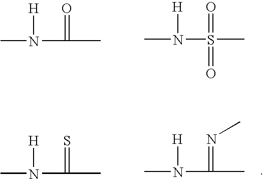

23. The positive photosensitive composition of claim 22, further comprising an alkali-soluble resin selected from a sulfonicimide-based polymer, a polymer containing a carboxyl group, and a polymer containing a sulfonamide group.

24. The positive photosensitive composition of claim 22, wherein the (B) high-molecular compound is a novolac-based phenol resin that is mixture of phenol and cresol containing 30 to 85% by mole of a phenol as a structural unit.
